(19) United States
(12) Patent Application Publication
(10) Pub. No.: US 2026/0039828 A1
(43) Pub. Date: Feb. 5, 2026

(54) METHOD AND APPARATUS FOR IMAGE PROCESSING USING ARTIFICIAL INTELLIGENCE TECHNOLOGY

(71) Applicant: AIONFLOW Co., Ltd., Ansan-si (KR)

(72) Inventors: Sangyoun LEE, Seoul (KR); Yongje KIM, Ansan-si (KR); Woojin KIM, Seoul (KR); Chajin SHIN, Seoul (KR); Sangjin LEE, Seoul (KR); Minhyeok LEE, Seoul (KR); Honggoo KANG, Seoul (KR)

(21) Appl. No.: 19/353,059

(22) Filed: Oct. 8, 2025

Related U.S. Application Data
(63) Continuation of application No. PCT/KR2024/006804, filed on May 20, 2024.

(30) Foreign Application Priority Data
May 18, 2023 (KR) 10-2023-0064324
Jun. 26, 2023 (KR) 10-2023-0082113
Aug. 25, 2023 (KR) 10-2023-0112232
Aug. 25, 2023 (KR) 10-2023-0112247
Aug. 25, 2023 (KR) 10-2023-0112252
May 17, 2024 (KR) 10-2024-0064400

(51) Int. Cl. H04N 19/132; H04N 19/169; H04N 19/172; H04N 19/59; H04N 19/70

(52) U.S. Cl. CPC H04N 19/132; H04N 19/172; H04N 19/188; H04N 19/59; H04N 19/70

(57) ABSTRACT

The present disclosure discloses an image processing method. The image processing method of the present disclosure may include obtaining image data including a plurality of image frames, performing preprocessing on the image data, encoding the preprocessed image data to generate encoded image data, and transmitting the encoded image data and information related to the preprocessing.

### CROSS-REFERENCE TO RELATED APPLICATION(S)

This application is a continuation application, claiming priority under 35 U.S.C. § 365(c), of an International application No. PCT/KR2024/006804, filed on May 20, 2024, which is based on and claims the benefit of a Korean patent application number 10-2023-0064324, filed on May 18, 2023, in the Korean Intellectual Property Office, of a Korean patent application number 10-2023-0082113, filed on Jun. 26, 2023, in the Korean Intellectual Property Office, of a Korean patent application number 10-2023-0112232, filed on Aug. 25, 2023, in the Korean Intellectual Property Office, of a Korean patent application number 10-2023-0112247, filed on Aug. 25, 2023, in the Korean Intellectual Property Office, of a Korean patent application number 10-2023-0112252, filed on Aug. 25, 2023, in the Korean Intellectual Property Office, and of a Korean patent application number 10-2024-0064400, filed on May 17, 2024, issued as a Korean Patent No. 10-2813974 on May 23, 2025, in the Korean Intellectual Property Office, the disclosure of each of which is incorporated by reference herein in its entirety.

### BACKGROUND

### 1. Field

The present disclosure relates to a method and apparatus for image processing using artificial intelligence technology.

### 2. Description of Related Art

To compress and restore image data, standardized codec technologies (e.g., H.264/AVC (Advanced Video Coding), H.265/HEVC (High Efficiency Video Coding)) are mainly used. Although standardized codec technologies have high efficiency and compatibility, in recent environments where data traffic is rapidly increasing due to rising demand for high-definition streaming services, they are becoming insufficient to guarantee adequate performance as compression technologies.

Due to this, demand is increasing for new types of image processing technologies capable of stably transmitting high-definition images with high compression efficiency, storing them at low cost and reproducing them with high quality.

### SUMMARY

The present disclosure provides a method for stably transmitting and storing original video (e.g., high-quality video) with high compression efficiency, and reproducing it with substantially the same quality (e.g., high quality) or higher than the original video. The present disclosure provides pre-processing and post-processing methods for providing high-efficiency compression and high-quality images. The pre-processing and post-processing methods of the present disclosure may have high compatibility with encoding/decoding techniques using standardized codec technology. The present disclosure provides a pre-processing method using frame skipping technology, and a post-processing method using frame interpolation technology and/or image quality enhancement technology. Through this, even while supporting high compression efficiency, quality at a level substantially the same as or higher than the original image can be provided.

The present disclosure provides a pre-processing method using a down-scaling technique of images and a latent vector technique that expresses losses caused thereby as latent vectors, and a post-processing method using super-resolution (SR) technology for resolution enhancement. Through this, even while supporting high compression efficiency, quality at a level substantially the same as or higher than the original image can be provided. The present disclosure provides a pre-processing method using frame selection technology, down-scaling technology, and latent vector technology in combination, and a post-processing method using frame interpolation technology, image quality enhancement technology, and super-resolution technology in combination. Through this, even while supporting high compression efficiency, quality at a level substantially the same as or higher than the original image can be provided.

The present disclosure provides a method for stably transmitting and storing original video (e.g., high-quality video) with high compression efficiency and reproducing it with substantially the same quality (e.g., high quality) or higher than the original video. The present disclosure provides a post-processing method using enhancement technology that restores decoded frames using reference frame (e.g., I-frame) of the corresponding frame group and reference frame (e.g., I-frame) of a subsequent frame group. Through this, distortion between frame groups (e.g., GoPs (Group of Pictures)) can be restored. In the present disclosure, reference frames may be referred to as key frames.

The pre-processing and post-processing methods of the present disclosure can be implemented using an artificial intelligence model. Through this, image processing with high speed and high accuracy can be supported.

### BRIEF DESCRIPTION OF DRAWINGS

The same or similar reference denotations may be used to refer to the same or similar elements throughout the specification and the drawings;

FIG. 1 schematically illustrates an image processing system according to an embodiment of the present disclosure.

FIG. 2A is a schematic block diagram of an image transmission device and an image reception device according to an embodiment of the present disclosure.

FIG. 2B is a schematic block diagram of an image transmission device and an image reception device according to an embodiment of the present disclosure.

FIG. 3 illustrates a frame skipping processing module of a preprocessing unit according to an embodiment of the present disclosure.

FIG. 4 schematically illustrates an operation of a frame skipping processing module according to an embodiment of the present disclosure.

FIG. 5 is a flowchart of a frame skipping processing method according to an embodiment of the present disclosure.

FIG. 6 illustrates a frame skipping application decision operation of a frame skipping processing method according to an embodiment of the present disclosure.

FIG. 7 shows an example of a model for determining whether to apply frame skipping according to an embodiment of the present disclosure.

FIG. 8A illustrates an example of a rate-distortion curve and a target rate-distortion point on a rate-distortion plane according to an embodiment of the present disclosure.

FIG. 8B illustrates an example of a distance between a rate-distortion curve and a target rate-distortion point according to an embodiment of the present disclosure.

FIG. 9 illustrates an example of a method for obtaining a distance between a rate-distortion curve and a target rate-distortion point according to an embodiment of the present disclosure.

FIG. 10 illustrates a frame interpolation processing module and a quality enhancement processing module of a post-processing unit according to an embodiment of the present disclosure.

FIG. 11 schematically illustrates operations of frame interpolation processing module and quality enhancement processing module according to an embodiment of the present disclosure.

FIG. 12 is a flowchart of a frame interpolation processing method according to an embodiment of the present disclosure.

FIG. 13 shows an example of a model for frame interpolation processing according to an embodiment of the present disclosure.

FIG. 14 shows an example of a model for quality enhancement processing according to an embodiment of the present disclosure.

FIG. 15 is a flowchart of an image processing method of an image transmission device according to an embodiment of the present disclosure.

FIG. 16 is a flowchart of an image processing method of an image reception device according to an embodiment of the present disclosure.

FIG. 17 illustrates a down-sampling processing module and a latent vector generation processing module of a pre-processing unit according to an embodiment of the present disclosure.

FIG. 18 schematically illustrates operations of down-sampling processing module and latent vector generation processing module according to an embodiment of the present disclosure.

FIG. 19 is a flowchart of a latent vector generation method according to an embodiment of the present disclosure.

FIG. 20 shows an example of a model for latent vector generation processing according to an embodiment of the present disclosure.

FIG. 21 illustrates a super-resolution processing module of a post-processing unit according to an embodiment of the present disclosure.

FIG. 22A illustrates an operation of super-resolution processing module according to an embodiment of the present disclosure.

FIG. 22B shows an example of a model for super-resolution processing according to an embodiment of the present disclosure.

FIG. 23 illustrates an example of an image processing procedure according to an embodiment of the present disclosure.

FIG. 24 is a flowchart of an image processing method of an image transmission device according to an embodiment of the present disclosure.

FIG. 25 is a flowchart of an image processing method of an image reception device according to an embodiment of the present disclosure.

FIG. 26 illustrates an example configuration of a pre-processing unit according to an embodiment of the present disclosure.

FIG. 27 illustrates an example configuration of a post-processing unit according to an embodiment of the present disclosure.

FIG. 28 illustrates an example of an image processing procedure according to an embodiment of the present disclosure.

FIG. 29 illustrates original video and encoded video according to an embodiment of the present disclosure.

FIG. 30 illustrates an image displaying first part of original video in chronological order and an image displaying second part corresponding to first part of original video in chronological order according to an embodiment of the present disclosure.

FIG. 31 illustrates a GoP enhancement processing module of a post-processing unit according to an embodiment of the present disclosure.

FIG. 32 illustrates an operation of GoP enhancement processing module according to an embodiment of the present disclosure.

FIG. 33 illustrates an example of a procedure for alignment processing of GoP enhancement processing module according to an embodiment of the present disclosure.

FIG. 34 is a flowchart of an image processing method of an image reception device according to an embodiment of the present disclosure.

FIG. 35 is a flowchart of an alignment processing operation of an image reception device according to an embodiment of the present disclosure.

FIG. 36 is a diagram illustrating a format for storing codec metadata according to an embodiment of the present disclosure.

FIGS. 37 and 38 are diagrams illustrating a method for transmitting media data and metadata according to an embodiment of the present disclosure.

FIGS. 39A and 39B are diagrams illustrating a super-resolution procedure according to an embodiment of the present disclosure.

FIGS. 40A and 40A are diagrams illustrating a frame skipping procedure according to an embodiment of the present disclosure.

### DETAILED DESCRIPTION

Hereinafter, embodiments of the present disclosure will be described in detail with reference to the drawings so that those of ordinary skill in the art to which the present disclosure pertains may easily carry out the present disclosure. However, the present disclosure may be implemented in various different forms and is not limited to the embodiments described herein. In connection with the descriptions of the drawings, the same or similar reference numerals may be used for the same or similar components. Also, in the drawings and the related description, descriptions of well-known functions and configurations may be omitted for clarity and brevity.

At this time, it can be understood that each block of the processing flowchart drawings and combinations of the flowchart drawings can be executed by computer program instructions.

In addition, each block may represent a module, segment, or portion of code that includes one or more executable instructions for implementing specified logical functions. Also, in some alternative embodiments, it should be noted that the functions referred to in the blocks can occur out of the described order. For example, two blocks shown in succession may in fact be executed substantially simultaneously or, depending on the corresponding function, be executed in reverse order.

At this point, the term “˜ unit” as used in the present embodiment refers to a software or a hardware component such as a Field Programmable Gate Array (FPGA), or an Application Specific Integrated Circuit (ASIC), and the “˜ unit” performs certain roles. However, “˜ unit” is not limited to software or hardware. The “˜ unit” may also be configured to reside in an addressable storage medium or configured to reproduce one or more packet processing devices. Therefore, by way of example, the “˜ unit” includes software components, object-oriented software components, class components, and task components, as well as processes, functions, attributes, procedures, subroutines, segments of program code, drivers, firmware, microcode, circuits, data, databases, data structures, tables, arrays, and variables. The functions provided within the components and “˜ units” may be combined into fewer components and “˜ units” or further divided into additional components and “˜ units.” Furthermore, the components and “˜ units” may be implemented to reproduce one or more central processing units (CPUs) within a device or a secure multimedia card. In addition, in the embodiment, the “˜ unit” may include one or more packet processing devices.

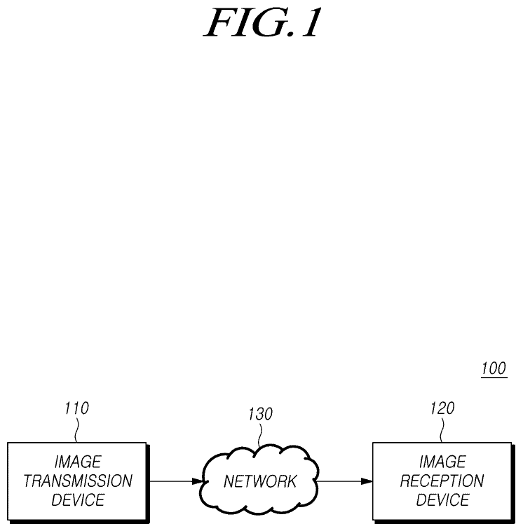

FIG. 1 schematically illustrates an image processing system according to an embodiment of the present disclosure.

Referring to FIG. 1, the image processing system 100 may include an image transmission device 110 and an image reception device 120. In the present disclosure, the image transmission device 110 may be referred to as an image providing device, and the image reception device 120 may be referred to as an image playback device.

According to an embodiment, the image transmission device 110 may transmit an image signal (or image data) including video and/or images to the image reception device 120 via a network 130, and the image reception device 120 may receive the image signal from the image transmission device 110.

According to an embodiment, the image transmission device 110 may encode the image signal to generate a compressed image signal. The image transmission device 110 may, for example, encode the image signal within a preset compression rate range to efficiently store, transmit, and manage the image signal. The image signal may include, for example, streaming images, camera images, video images, uncompressed images, video conference images, and/or game images, but is not limited thereto.

According to an embodiment, the image transmission device 110 may include various image source devices such as a TV, personal computer (PC), smartphone, tablet, set-top box, game console, or server. According to an embodiment, the image reception device 120 may include various image playback devices such as a TV, smartphone, tablet, or PC. It is apparent to those skilled in the art that the image transmission device 110 and the image reception device 120 are not limited to specific types of devices.

According to an embodiment, the image transmission device 110 and the image reception device 120 may transmit and receive the image signal through the network 130. The network 130 may include, for example, short-range communication networks such as Wi-Fi, or long-range communication networks such as cellular networks, next-generation communication networks, the Internet, or computer networks (e.g., local area networks (LANs) or wide area networks (WANs)), and may communicate based on an Internet Protocol (IP). The cellular network may include GSM (Global System for Mobile Communications), EDGE (Enhanced Data GSM Environment), CDMA (Code Division Multiple Access), TDMA (Time Division Multiplexing Access), LTE (Long Term Evolution), LTE-A (LTE Advanced), 5G NR (New Radio), and post-5G communication networks (e.g., 6G or beyond). The network 130 may include connections of network elements such as hubs, bridges, routers, switches, and gateways. The network 130 may include one or more connected networks, such as public networks like the Internet and private networks like enterprise private networks, including multi-network environments. Access to the network 130 may be provided via one or more wired or wireless access networks. The network 130 may support an Internet of Things (IoT) network that processes information exchanged among distributed components such as objects.

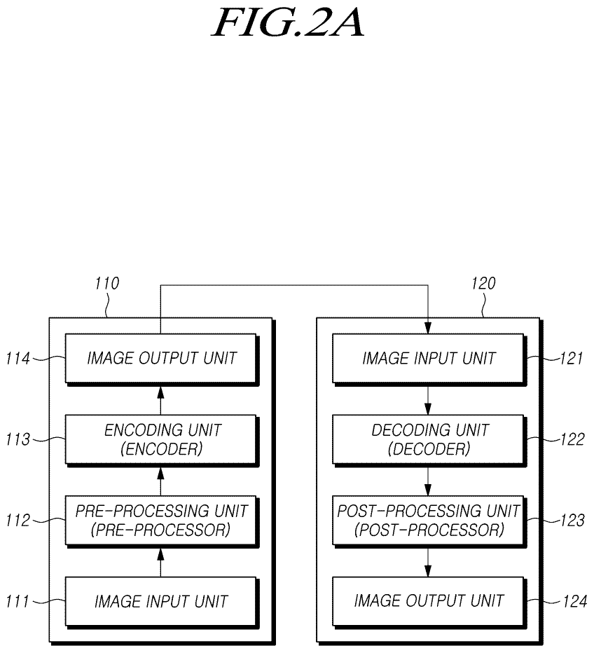

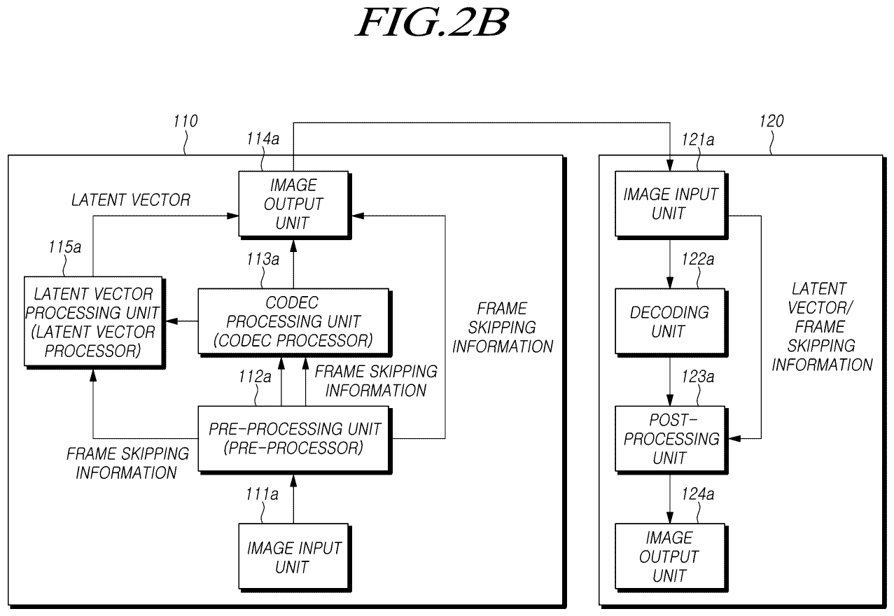

FIG. 2A is a schematic block diagram of an image transmission device and an image reception device according to an embodiment of the present disclosure.

Referring to FIG. 2A, the image transmission device 110 may include an image input unit 111, a pre-processing unit 112, an encoding unit 113, and an image output unit 114. The image transmission device 110 may include additional components other than the illustrated components or may omit at least one of the illustrated components. For example, the image transmission device 110 may further include a memory, at least one processor including a processing circuitry, and a communication interface including a communication circuitry. Each component of the image transmission device 110 may be implemented by the memory, at least one processor, and/or the communication circuitry.

According to an embodiment, the memory may store data such as a program including one or more instructions or setting information. The memory may include, for example, volatile memory, non-volatile memory, or a combination of both volatile and non-volatile memory. The memory may provide stored data in response to a request from the processor.

According to an embodiment, the communication interface may provide an interface for communication with other systems or devices. The communication interface may include a network interface card or a wireless transceiver that enables communication via the network 130. The communication interface may perform signal processing to access a wireless network. The wireless network may include at least one of a short-range communication network or a cellular network (e.g., LTE, 5G NR).

According to an embodiment, the at least one processor is electrically connected to the communication interface and the memory, and may perform operations or data processing related to control and/or communication of at least one other component of the image transmission device 110 using a program stored in the memory. The processor may execute at least one instruction corresponding to the image input unit (or, image input interface) 111, the pre-processing unit (or, pre-processor) 112, the encoding unit (or, encoder) 113, and the image output unit (or, image output interface) 114. The processor may include, for example, at least one of a central processing unit (CPU), a graphics processing unit (GPU), a microcontroller unit (MCU), a sensor hub, a supplementary processor, a communication processor, an application processor, an application-specific integrated circuit (ASIC), or a field-programmable gate array (FPGA), and may have multiple cores.

According to an embodiment, the image input unit 111 may obtain an image signal. The image signal may be received from outside the image transmission device 110 or may be generated by the image transmission device 110. The image input unit 111 may receive the image signal externally in a wired or wireless manner via the communication interface or communication circuit.

According to an embodiment, the pre-processing unit 112 may perform pre-processing on the image signal input by the image input unit 110 before encoding by the encoding unit 113. For example, the pre-processing unit 112 may perform frame skipping processing on the input image signal, down-sampling processing on the input image signal, and/or latent vector processing for expressing the loss due to the down-sampling processing as latent vector data.

According to an embodiment, the pre-processing unit 112 may be implemented by a pre-trained model (e.g., an artificial intelligence (AI) model).

According to an embodiment, the artificial intelligence model may be generated through machine learning. Such learning may be performed, for example, on the electronic device (e.g., the image transmission device 110 or the image reception device 120) in which the artificial intelligence model is used, or may be performed through a separate electronic device (e.g., a server). The learning algorithm may include, for example, supervised learning, unsupervised learning, semi-supervised learning, or reinforcement learning, but is not limited thereto. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above, but is not limited to these examples. The artificial intelligence model may include, in addition to hardware structure, a software structure additionally or alternatively.

Meanwhile, depending on the embodiment, all or part of the operations of the pre-processing unit 112 may be omitted. For example, all or part of the frame skipping processing, down-sampling processing, and latent vector processing of the pre-processing unit 112 may be omitted. If all operations of the pre-processing unit 112 are omitted, the input image of the image transmission device 110 may be delivered to the image reception device 120 after only undergoing encoding processing by the encoding unit 113.

According to an embodiment, the encoding unit 113 may encode the image signal input by the image input unit 110 or the image signal pre-processed by the pre-processing unit 112. The encoding unit 113 may perform a series of processes such as prediction, transformation, and quantization for compression and encoding efficiency.

According to an embodiment, the encoding unit 113 may encode the image signal using a predetermined encoding scheme and encoding parameters associated with the encoding scheme. The encoding scheme may follow, for example, a standardized codec technology (e.g., H.264/AVC standard, H.265/HEVC standard) or AI codec technology, but is not limited thereto. The encoding parameters may include at least one parameter used (or set) for encoding (or compressing) the image signal according to the standardized codec technology (e.g., H.264/AVC, H.265/HEVC). The at least one parameter may include, for example, a parameter related to compression rate (or compression quality) and/or a parameter related to bitrate, such as a quantization parameter (QP). Generally, a lower QP value results in less quantization, thereby providing higher image quality but requiring a higher bitrate. In the present disclosure, the encoding scheme may be referred to as a compression scheme, and the encoding parameter may be referred to as a compression parameter.

According to an embodiment, the encoding unit 113 may provide the encoded image signal (or encoded data) to the image output unit 114 in the form of a bitstream.

According to an embodiment, the pre-processing unit 112 and the encoding unit 113 may be integrated into one component. For example, the pre-processing unit 112 may be included in the encoding unit 113. For instance, when the encoding unit 113 uses AI codec technology, the pre-processing unit 112 may be a component included in the encoding unit 113. If the pre-processing unit 112 is included in the encoding unit 113, the operations of the pre-processing unit 112 may be performed before the encoding operation of the encoding unit 113, but are not limited thereto. For example, depending on the embodiment, the operations of the pre-processing unit 112 may be performed together with or after the encoding operation of the encoding unit 113. In one example, the operations of the pre-processing unit 112 and the encoding unit 113 may be performed together through at least one AI model.

According to an embodiment, the image output unit 114 may transmit the encoded image signal to the image reception device 120 via the communication interface.

According to an embodiment, the image output unit 114 may transmit information related to pre-processing (e.g., frame skip information) along with the encoded image signal to the image reception device 120 via the communication interface or communication circuitry. The information related to pre-processing (or frame skipping information) may include, for example, information indicating whether frame skipping is applied to the corresponding frame, and/or information about the number of frames (e.g., information about frame rate such as FPS (frames per second)), but is not limited thereto. In the present disclosure, the frame may be referred to as an image frame.

Such related information may be used for image processing at the image reception device 120. For example, frame skipping-related information may be used by the image reception device 120 to determine whether to apply frame interpolation to the corresponding frame. For example, the information about frame rate may be used by the image reception device 120 to determine whether frame skipping was applied at the image transmission device 110. For example, if the frame rate information is lower than the frame rate (e.g., 30 FPS) of the input image, the image reception device 120 may determine that frame skipping was applied at the image transmission device 110. For example, if the frame rate information is the same as the frame rate (e.g., 30 FPS) of the input image, the image reception device 120 may determine that frame skipping was not applied at the image transmission device 110.

According to an embodiment, the information related to pre-processing may be added to the bitstream including the encoded data. For example, the information related to pre-processing may be included in an optional region of the bitstream. For instance, the information related to pre-processing may be included in a description region of the bitstream, but is not limited thereto. The description region may be a region for describing information and structure of the bitstream. For example, the description region may include codec information indicating which codec the bitstream is compressed with, media information indicating what type of media data the bitstream contains, encoding setting information including encoding parameters of the codec, and/or timestamp or time information of each frame associated with the bitstream.

The image reception device 120 may include an image input unit (or, image input interface) 121, a decoding unit (or, decoder) 122, a post-processing unit (or, post-processor) 123, and an image output unit (or, image output interface) 124. The image output unit 124 may include, for example, a display unit, and the display unit may be configured as a separate device or an external component. The image reception device 120 may include additional components other than the illustrated components or may omit at least one of the illustrated components. For example, the image reception device 120 may further include a memory, at least one processor including a processing circuitry, and a communication interface including a communication circuitry. Each component of the image reception device 120 may be implemented by the memory, at least one processor, and/or the communication circuitry. The descriptions of the memory, at least one processor, and communication interface of the image reception device 120 may refer to the aforementioned descriptions of the memory, at least one processor, and communication interface of the image transmission device 110. Accordingly, redundant descriptions with the above are omitted.

According to an embodiment, the at least one processor is electrically connected to the communication interface and the memory, and may perform operations or data processing related to control and/or communication of at least one other component of the image reception device 120 using a program stored in the memory. The processor may execute at least one instruction corresponding to the image input unit 121, the decoding unit 122, the post-processing unit 123, and the image output unit 124. The processor may include, for example, at least one of a CPU, GPU, MCU, sensor hub, supplementary processor, communication processor, application processor, ASIC, or FPGA, and may have multiple cores.

According to an embodiment, the image input unit 121 may obtain an image signal. The image input unit 121 may receive the image signal from the image transmission device 110 via the communication interface or communication circuitry. The image input unit 121 may receive the image signal from the image transmission device 110 in a wired or wireless manner via the communication interface or communication circuit.

According to an embodiment, the image input unit 121 may extract (or obtain) the encoded image signal and/or information related to pre-processing from a bitstream received from the image transmission device 110. The image input unit 121 may deliver the obtained encoded image signal and/or information related to pre-processing to the decoding unit 122.

According to an embodiment, the decoding unit 122 may decode the image signal input by the image input unit 121. For example, the decoding unit 122 may decode the image signal by performing a series of procedures such as inverse quantization, inverse transform, and prediction corresponding to the operations of the encoding unit 113.

According to an embodiment, the decoding unit 122 may decode the image signal using a predetermined decoding scheme and decoding parameters associated with the decoding scheme. The decoding scheme according to an embodiment may correspond to the encoding scheme of the encoding unit 113, and the decoding parameters may correspond to the encoding parameters associated with the encoding scheme of the encoding unit 113. For example, the same standard codec technology (e.g., H.264/AVC, H.265/HEVC) or AI codec technology may be used for both encoding and decoding, and a parameter (e.g., inverse quantization parameter) corresponding to a parameter used for encoding (e.g., QP) may be used for decoding. According to an embodiment, the value of the parameter for decoding (e.g., inverse quantization parameter) may be set depending on the value of the corresponding parameter (e.g., QP) for encoding. In the present disclosure, the decoding scheme may be referred to as a reconstruction scheme, and the decoding parameters may be referred to as reconstruction parameters.

According to an embodiment, the post-processing unit 123 may perform post-processing on the image signal decoded by the decoding unit 122.

For example, the post-processing unit 123 may perform frame interpolation processing on the decoded image signal. Through this, skipped frames may be regenerated. For example, the post-processing unit 123 may perform quality enhancement processing on the decoded image signal. Through this, the quality of degraded image data may be compensated (or enhanced). For example, the post-processing unit 123 may perform frame interpolation processing on the decoded image signal and then perform quality enhancement processing on the frame-interpolated image signal. Through this, skipped frames may be regenerated and the quality of degraded image data may be enhanced, thereby providing an image of substantially the same quality as the original image.

For example, the post-processing unit 123 may perform super-resolution (SR) processing on the decoded image signal. Through this, the resolution of a downscaled image may be improved.

For example, the post-processing unit 123 may perform group of pictures (GoP)-based enhancement (hereinafter referred to as GoP enhancement) processing on the decoded image signal. Through this, temporally smoothed images may be provided. As an embodiment, the GoP enhancement processing may be an example of the aforementioned quality enhancement processing.

For example, the post-processing unit 123 may perform frame interpolation processing, quality enhancement processing, and SR processing on the decoded image signal. Through this, the image pre-processed for compression efficiency may be restored, and the quality of the image may be improved.

According to an embodiment, the post-processing unit 123 may perform post-processing operations corresponding to pre-processing operations performed in the pre-processing unit 112, based on information related to pre-processing. For example, when it is identified based on frame skipping-related information that frame skipping has been performed on the input image signal by the pre-processing unit 112, the post-processing unit 123 may perform frame interpolation processing on the image signal to which frame skipping was applied. For example, when down-scaling and latent vector processing have been performed on the input image signal by the pre-processing unit 112, the post-processing unit 123 may perform SR processing.

According to an embodiment, the post-processing unit 123 may be implemented using a pre-trained model (e.g., an artificial intelligence model).

Meanwhile, the image reception device 120 may not include a post-processing unit that performs the functions of the post-processing unit 123 described above. In this case, even if the image reception device 120 receives information related to pre-processing from the bitstream received from the image transmission device 110, it may not be able to perform operations corresponding to the information. For example, even if the image reception device 120 obtains frame skipping-related information included in the bitstream, it may not be able to perform the determination processing of whether to apply frame interpolation to the corresponding frame and the interpolation processing of the corresponding frame based on the information. However, the image reception device 120 may identify that frame skipping has been performed by the image transmission device 110 based on the frame skipping-related information and/or information about the number of frames, and may perform frame interpolation processing at a preset fixed position using a general frame interpolation method.

According to an embodiment, the post-processing unit 123 and the decoding unit 122 may be integrated into one component. For example, the post-processing unit 123 may be included in the decoding unit 122. For instance, when the decoding unit 122 uses AI codec technology, the post-processing unit 123 may be a component included in the decoding unit 122. If the post-processing unit 123 is included in the decoding unit 122, the operations of the post-processing unit 123 may be performed after the decoding operation of the decoding unit 122, but are not limited thereto. For example, depending on the embodiment, the operations of the post-processing unit 123 may be performed together with or after the decoding operation of the decoding unit 122. In one example, the operations of the post-processing unit 123 and the decoding unit 122 may be performed together through at least one AI model.

According to an embodiment, the image output unit 124 may output the image signal decoded by the decoding unit 122 or the image signal post-processed by the post-processing unit 123. For example, the image output unit 124 may render the decoded image signal or the post-processed image signal. The rendered image signal may be displayed through a display, for example.

FIG. 2B is a schematic block diagram of an image transmission device and an image reception device according to an embodiment of the present disclosure.

Referring to FIG. 2B, the image transmission device 110 may include an image input unit (or, image input interface) 111a, a pre-processing unit (or, pre-processor) 112a, a codec processing unit (or, encoder/decoder) 113a, an image output unit (or, image output interface) 114a, and a latent vector processing unit (or, latent vector processor) 115a. The image transmission device 110 may include additional components other than the illustrated components, or may omit at least one of the illustrated components. For example, the image transmission device 110 may further include a memory, at least one processor including a processing circuitry, and/or a communication interface including a communication circuitry. Each component of the image transmission device 110 may be implemented by the memory, the at least one processor, and/or the communication circuitry. The description of the memory, the at least one processor, and the communication interface of the image transmission device 110 may refer to the description of FIG. 2A. Accordingly, redundant descriptions are omitted.

According to an embodiment, the image input unit 111a may perform all or part of the operations performed by the image input unit 111 of FIG. 2A, and may further perform additional operations.

According to an embodiment, the pre-processing unit 112a may perform all or part of the operations performed by the pre-processing unit 112 of FIG. 2A, and may further perform additional operations. The pre-processing unit 112a may pre-process the image signal input by the image input unit 111a before codec processing by the codec processing unit 113a.

For example, the pre-processing unit 112a may perform frame skipping processing on the image signal input by the image input unit 111a. In this case, the pre-processing unit 112a may deliver frame skipping information to the codec processing unit 113a, the image output unit 114a, and/or the latent vector processing unit 115a.

For example, the pre-processing unit 112a may perform down-sampling processing on the image signal input by the image input unit 111a. For example, the pre-processing unit 112a may perform both frame skipping processing and down-sampling processing on the image signal input by the image input unit 111a.

According to an embodiment, the pre-processing unit 112a may be implemented by a pre-trained model (e.g., an artificial intelligence (AI) model). The description of the artificial intelligence model may refer to the description of FIG. 2A, and redundant descriptions are omitted.

According to an embodiment, the codec processing unit 113a may perform codec processing on the image signal input by the image input unit 110 or the pre-processed image signal by the pre-processing unit 112. The codec processing of the codec processing unit 113a may include, for example, encoding processing and encoding/decoding processing. The encoding processing of the codec processing unit 113a may be the same as the encoding processing of the encoding unit 113 in FIG. 2A, and the decoding processing of the codec processing unit 113a may be the same as the decoding processing of the decoding unit 122 in FIG. 2A. Accordingly, redundant descriptions are omitted.

For example, the codec processing unit 113a may perform encoding processing on the image pre-processed by the pre-processing unit 112 (e.g., frame-skipped image, down-sampled image) and may deliver the encoded image (e.g., codec bitstream) to the image output unit 114a.

For example, the codec processing unit 113a may perform encoding and decoding on the image pre-processed by the pre-processing unit 112 (e.g., frame-skipped image, down-sampled image), and may deliver the encoded and decoded image to the latent vector processing unit 115a. In this case, the latent vector processing unit 115a may generate a latent vector using the encoded and decoded image. As such, the latent vector processing unit 115a may generate the latent vector using the encoded and decoded image, which is image degraded due to compression.

According to an embodiment, the latent vector processing unit 115a may generate a latent vector using the encoded and decoded image delivered from the codec processing unit 113a and/or the frame skipping information delivered from the pre-processing unit 112a. For example, the latent vector processing unit 115a may generate a latent vector for the down-sampled image using the encoded and decoded image of the down-sampled image. For example, the latent vector processing unit 115a may generate a latent vector for the frame-skipped image using the encoded and decoded image of the frame-skipped image and the frame skipping information.

According to an embodiment, the latent vector processing unit 115a may deliver the generated latent vector to the image output unit 114a.

According to an embodiment, the image output unit 114a may perform all or part of the operations performed by the image output unit 114 of FIG. 2A and may further perform additional operations.

For example, the image output unit 114a may transmit a signal including the encoded image (e.g., codec bitstream) delivered from the codec processing unit 113a, the latent vector delivered from the latent vector processing unit 115a, and/or the frame skipping information delivered from the pre-processing unit 112a to the image reception device 120 via the communication interface or communication circuitry.

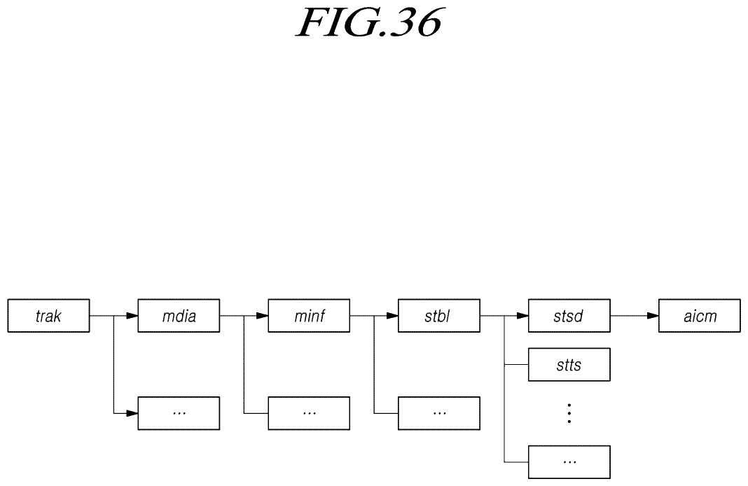

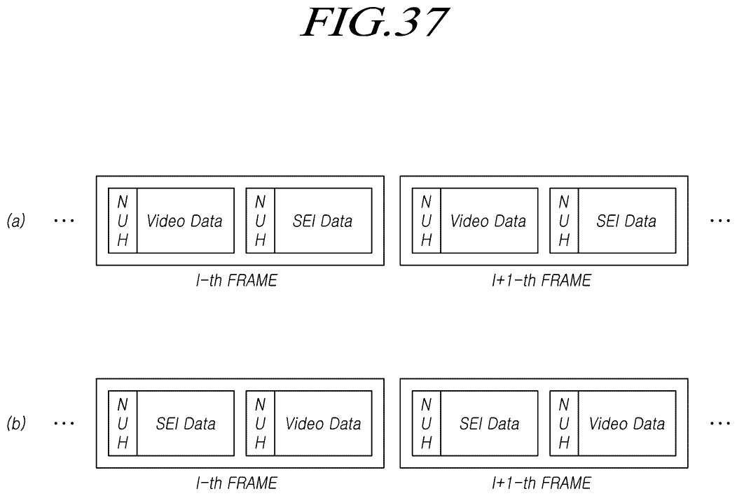

The final bitstream including the encoded image, the latent vector, and/or the frame skipping information may be included in one container and transmitted. Examples of storage and transmission methods for the encoded image, the latent vector, and/or the frame skipping information will be described later with reference to FIGS. 36 and 37.

According to an embodiment, the image reception device 120 may include an image input unit 121a, a decoding unit 122a, a post-processing unit 123a, and an image output unit 124a. The image reception device 120 may include additional components other than the illustrated components or may omit at least one of the illustrated components. For example, the image reception device 120 may further include a memory, at least one processor including a processing circuitry, and a communication interface including a communication circuitry. Each component of the image reception device 120 may be implemented by the memory, at least one processor, and/or the communication circuitry. The description of the memory, the at least one processor, and the communication interface of the image reception device 120 may refer to the description of FIG. 2A. Accordingly, redundant descriptions are omitted.

According to an embodiment, the image input unit 121a may perform all or part of the operations performed by the image input unit 121 of FIG. 2A and may further perform additional operations.

For example, the image input unit 121a may obtain the encoded image (e.g., codec bitstream), the latent vector, and/or the frame skipping information from the signal received from the image transmission device 110. The image input unit 121a may deliver the encoded image to the codec processing unit 122a, and may deliver the latent vector and/or the frame skipping information to the post-processing unit 123a.

According to an embodiment, the codec processing unit 122a may perform codec processing (e.g., decoding processing) on the encoded image delivered from the image input unit 121a. The decoding processing of the codec processing unit 122a may be the same as the decoding processing of the decoding unit 122 in FIG. 2A. Accordingly, redundant descriptions are omitted.

According to an embodiment, the post-processing unit 123a may perform all or part of the operations performed by the post-processing unit 123 of FIG. 2A and may further perform additional operations. The post-processing unit 123a may post-process the image decoded by the codec processing unit 122a.

For example, the post-processing unit 123a may perform frame interpolation processing on the decoded image using the latent vector and/or the frame skipping information. Through this, the skipped frame may be regenerated. For example, the post-processing unit 123a may perform quality enhancement processing on the decoded image signal. Through this, the quality of degraded image data may be compensated (or enhanced). For example, the post-processing unit 123a may perform frame interpolation processing on the decoded image signal and then perform quality enhancement processing on the frame-interpolated image signal. Through this, the skipped frame is regenerated and the quality of the degraded image data is enhanced, thereby providing an image of substantially the same quality as the original image.

For example, the post-processing unit 123a may perform super-resolution (SR) processing on the decoded image signal using the latent vector. Through this, the resolution of the downscaled image may be improved.

For example, the post-processing unit 123a may perform group of pictures (GoP)-based enhancement (hereinafter referred to as GoP enhancement) processing on the decoded image signal. Through this, temporally smoothed images may be provided. As an embodiment, the GoP enhancement processing may be an example of the quality enhancement processing described above.

For example, the post-processing unit 123a may perform frame interpolation processing, quality enhancement processing, and SR processing on the decoded image signal. Through this, the image pre-processed for compression efficiency may be restored, and the quality of the image may be improved.

According to an embodiment, the post-processing unit 123a may be implemented using a pre-trained model (e.g., an artificial intelligence model).

According to an embodiment, the image output unit 124a may perform all or part of the operations performed by the image output unit 124 of FIG. 2A and may further perform additional operations. The image output unit 124a may output the post-processed image by the post-processing unit 123a through a display.

Hereinafter, a pre-processing method using frame skipping technology and a post-processing method using frame interpolation and quality enhancement technologies will be described. Meanwhile, to determine whether to perform such pre-processing/post-processing methods, a frame skipping algorithm may be used. The frame skipping algorithm may be an algorithm used to determine whether it is advantageous to use a general compression/reconstruction scheme (e.g., compression/reconstruction using standard codec technology) or the proposed method using the frame skipping technology, frame interpolation technology, and quality enhancement technology of the present disclosure for a given frame. Through the determination using the frame skipping algorithm, according to the proposed method, it may be determined whether the image transmission device 110 performs frame skipping processing before compression and the image reception device 120 performs frame interpolation and quality enhancement processing after reconstruction, or whether the corresponding frame is to be processed according to the general compression/reconstruction scheme. As an embodiment, the method according to the frame skipping algorithm may be implemented by an AI model.

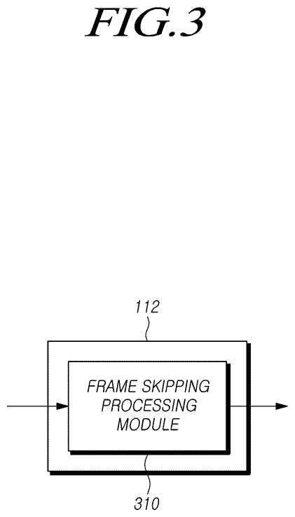

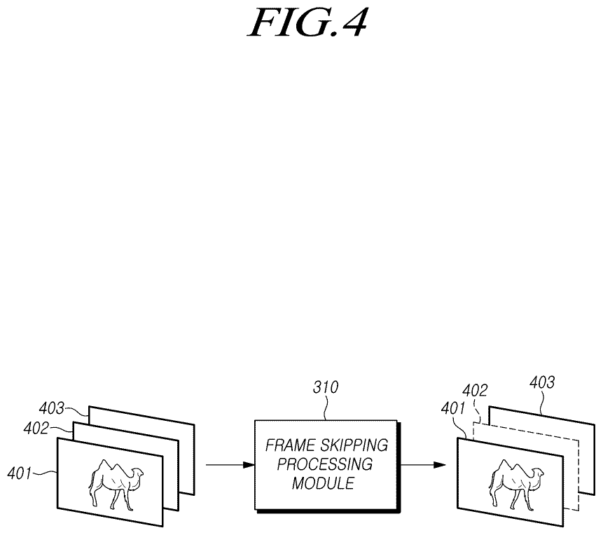

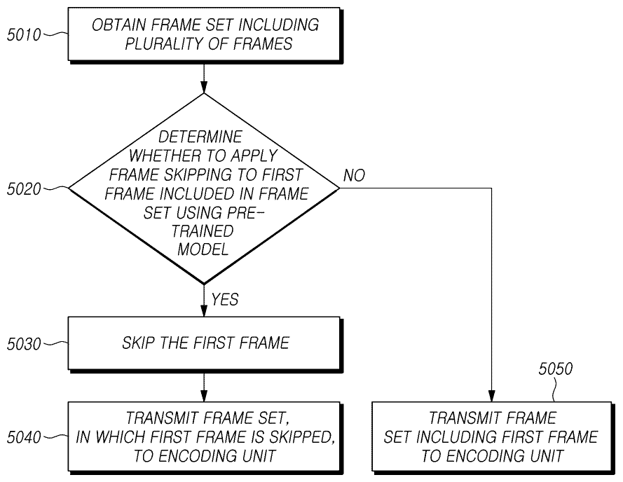

FIG. 3 illustrates a frame skipping processing module of a preprocessing unit according to an embodiment of the present disclosure. FIG. 4 schematically illustrates an operation of a frame skipping processing module according to an embodiment of the present disclosure. FIG. 5 is a flowchart of a frame skipping processing method according to an embodiment of the present disclosure.

With reference to FIG. 3, the preprocessing unit 112 may include a frame skipping processing module 310 for frame skipping processing. In the present disclosure, the operation of the frame skipping processing module 310 may be understood as the operation of at least one processor of the image transmission device 110 and/or the image transmission device 110.

According to an embodiment, the frame skipping processing module 310 may perform frame skipping processing on the input image signal. For example, the frame skipping processing module 310 may skip one frame among a plurality of identified frames (e.g., three or more frames, but not limited thereto). As illustrated in FIG. 4, for instance, the frame skipping processing module 310 may skip the middle frame 402 among three time-sequential frames (401, 402, 403) input to the frame skipping processing module 310. Thereafter, the frame skipping processing module 310 may transmit the remaining frames excluding the skipped frame (e.g., frames 401 and 403) to the encoding unit 113. The skipped frame is not encoded by the encoding unit 113, thereby reducing compression size. That is, such frame skipping processing can provide high compression efficiency.

According to an embodiment, the frame skipping processing module 310 may perform frame skipping processing on the input image signal using a pre-trained AI model (or a preconfigured frame skipping algorithm). For example, the frame skipping processing module 310 may determine whether to apply frame skipping to the corresponding frame using the pre-trained AI model. When it is determined that frame skipping is to be applied to the corresponding frame, the frame skipping processing module 310 may skip the frame and transmit the remaining frames excluding the skipped frame to the encoding unit 113. When it is determined that frame skipping is not to be applied to the corresponding frame, the frame skipping processing module 310 may transmit the frames including the corresponding frame to the encoding unit 113. Through such determination using the AI model, it is possible to accurately and rapidly determine whether frame skipping processing is advantageous or whether compression/restoration without frame skipping is advantageous.

According to an embodiment, the frame skipping processing module 310 may selectively determine whether to apply frame skipping to the corresponding frame. Through such selective frame skipping processing based on the determination, rather than always skipping a fixed-position frame, it is possible to prevent skipping of frame(s) for which quality restoration is difficult through frame interpolation and quality enhancement processing.

Hereinafter, with reference to FIG. 5, exemplary operations of the frame skipping processing method of the frame skipping processing module 310 will be described. Meanwhile, the following operations of the frame skipping processing module 310 may be understood as being controlled or performed by at least one processor of the image transmission device 110 and/or the image transmission device 110.

With reference to FIG. 5, in operation 5010, the frame skipping processing module 310 may obtain a frame set (or frame group) including a plurality of frames. For example, as illustrated in FIG. 4, in order to determine whether to apply frame skipping to the first frame 402, the frame skipping processing module 310 may obtain a frame set including the first frame 402, a previous frame of the first frame 402, i.e., frame 401, and a subsequent frame of the first frame 402, i.e., frame 403. Meanwhile, when the first frame of the frame set (e.g., frame 401, the previous frame of the first frame 402) is not an I (intra) frame (e.g., when it is an inter frame such as a P frame), the frame set may further include a previous frame of frame 401 (e.g., I frame). That is, the frame set may include four frames. The number of frames included in such a frame set may correspond to the number of frames required for encoding processing, for example.

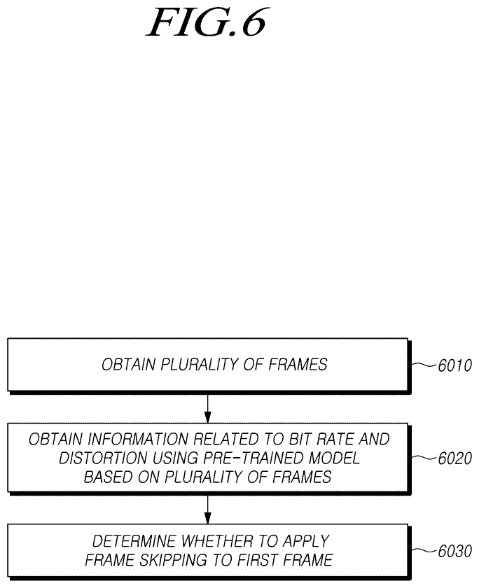

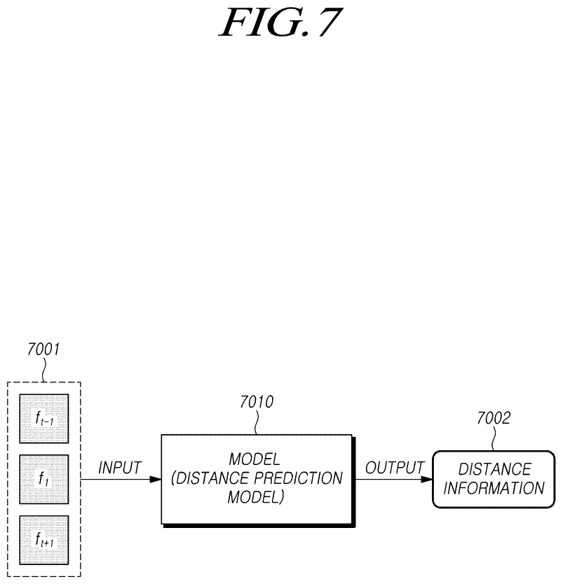

In operation 5020, the frame skipping processing module 310 may determine whether to apply frame skipping to the first frame 402 included in the frame set using a preconfigured algorithm/model (or a preconfigured frame skipping algorithm). For example, the frame skipping processing module 310 may determine whether to apply frame skipping to the first frame 402 using a pre-trained model (e.g., model 7010 in FIG. 7). Description on determining whether to apply frame skipping to the corresponding frame will be described below with reference to FIG. 6.

In operation 5030, when it is determined that frame skipping is to be applied to the first frame 402, the frame skipping processing module 310 may skip the first frame 402. For example, as shown in FIG. 4, the frame skipping processing module 310 may skip the first frame 402 between frame 401 and frame 403. The skipped first frame 402 is not encoded by the encoding unit.

In operation 5040, the frame skipping processing module 310 may transmit the frame set, in which the first frame 402 is skipped, to the encoding unit. For example, the frame skipping processing module 310 may transmit a frame set including frame 401 and frame 403, excluding the first frame 402, to the encoding unit. Meanwhile, as described above, when frame 401 is not an I-frame, the frame skipping processing module 310 may transmit a frame set including a previous frame of frame 401, frame 401, and frame 403 to the encoding unit. The transmitted frame set may be encoded by the encoding unit.

In operation 5050, when it is determined that frame skipping is not to be applied to the first frame 402, the frame skipping processing module 310 may transmit a frame set including frame 401, the first frame 402, and frame 403 to the encoding unit. Meanwhile, as described above, when frame 401 is not an I-frame, the frame skipping processing module 310 may transmit a frame set including a previous frame of frame 401, frame 401, the first frame 402, and frame 403 to the encoding unit. The transmitted frame set may be encoded by the encoding unit.

Below, with reference to FIG. 6, an exemplary description will be provided of the operation of determining whether to apply frame skipping by the frame skipping processing module 310.

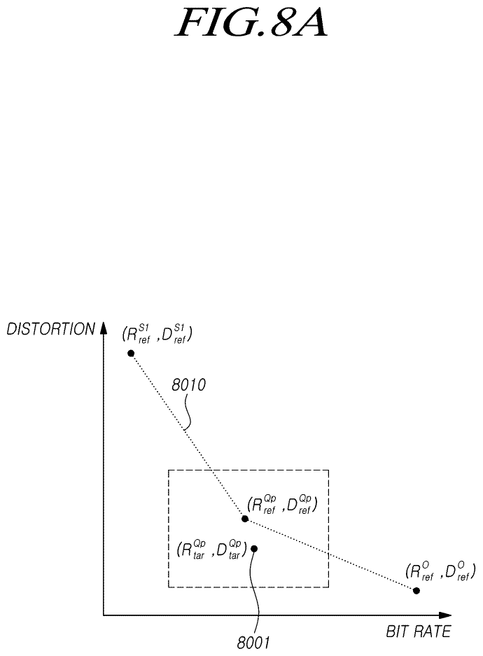

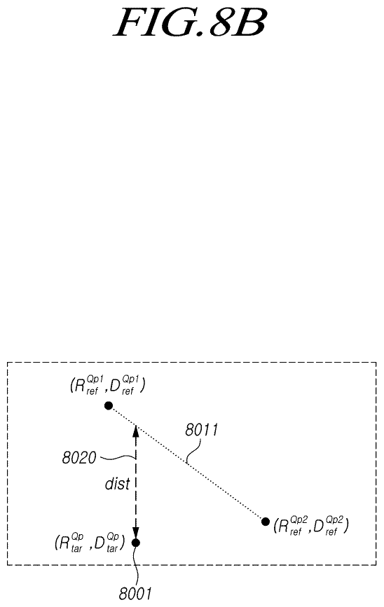

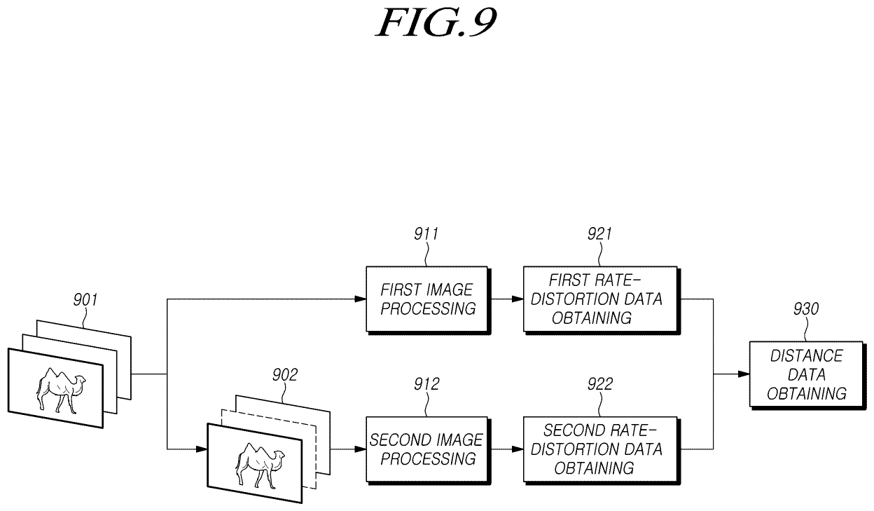

FIG. 6 illustrates a frame skipping application decision operation of a frame skipping processing method according to an embodiment of the present disclosure. FIG. 7 shows an example of a model for determining whether to apply frame skipping according to an embodiment of the present disclosure. FIG. 8A illustrates an example of a rate-distortion curve and a target rate-distortion point on a rate-distortion plane according to an embodiment of the present disclosure. FIG. 8B illustrates an example of a distance between a rate-distortion curve and a target rate-distortion point according to an embodiment of the present disclosure.

The operation of the frame skipping processing module 310 shown in FIG. 6 may be understood as being controlled or performed by at least one processor of the image transmission device 110 and/or the image transmission device 110.

Referring to FIG. 6, in operation 6010, the frame skipping processing module 310 may obtain a plurality of frames (e.g., a plurality of encoded and decoded frames or a plurality of original frames).

For example, in the case of determining whether to apply frame skipping to a first frame (e.g., frame 402 in FIG. 4), the frame skipping processing module 310 may obtain a plurality of encoded and decoded frames (e.g., encoded and decoded frames generated by encoding and decoding frames 401, 402, and 403 in FIG. 4), or a plurality of original frames (e.g., frames 401, 402, and 403 in FIG. 4). In the present disclosure, encoded and decoded frames may also be referred to as codec-processed frames.

In operation 6020, based on the plurality of frames (e.g., encoded and decoded frames or original frames), the frame skipping processing module 310 may obtain information related to bit rate and distortion (e.g., distance information related to bit rate and distortion, although not limited thereto), using a pre-trained model (or a preset frame skipping algorithm). For example, as illustrated in FIG. 7, the frame skipping processing module 310 may input a input data including a frame set 7001 comprising the plurality of encoded and decoded frames (e.g., encoded and decoded frames generated by encoding and decoding frames 401, 402, and 403 in FIG. 4) or the plurality of original frames (e.g., frames 401, 402, and 403 in FIG. 4) into the model 7010 (or a distance predictor), and obtain distance information 7002 as output data. In the present disclosure, the model 7010 may be referred to as a distance prediction model.

According to an embodiment, the distance information 7002 may include a distance associated with a difference between a first distortion and a second distortion at the same bit rate. The first distortion may be associated with a first frame set (first image frame set) where frame skipping is applied to the first frame, and the second distortion may be associated with a second frame set (second image frame set) where frame skipping is not applied to the first frame. The distance may correspond to the value obtained by subtracting the second distortion from the first distortion. Through such distance information obtained by an AI model, it can be quantitatively determined whether frame skipping processing is advantageous or whether compression/restoration without frame skipping is advantageous. For example, based on the distance information 7002, it may be determined whether the normal compression/restoration scheme (e.g., using standard codec technology) is advantageous, or whether the proposed scheme (using frame skipping, interpolation, and quality enhancement) is advantageous.

According to an embodiment, the distance prediction model may be an artificial intelligence model including multiple artificial neural network layers. The neural network may be, for example, one or a combination of two or more of DNN, CNN, RNN, RBM, DBN, BRDNN, deep Q-networks, etc., but is not limited thereto.

According to an embodiment, the distance prediction model may include an input layer, hidden layer(s), and an output layer. According to an embodiment, the distance prediction model may include an input layer, multiple convolution layers, fully connected layers, and an output layer.

According to an embodiment, the distance prediction model may be trained according to the compression scheme (e.g., trained per compression scheme) and/or compression parameters associated with the compression scheme (e.g., trained per compression parameter). For example, when the compression scheme follows the HEVC standard, the distance prediction models may be trained individually for each compression parameter (e.g., QP). For example, if four QPs are used in the compression scheme, four distance prediction models may be trained individually for each QP.

According to an embodiment, the frame skipping processing module 310 may select one distance prediction model among a plurality of pre-trained distance prediction models based on the compression scheme and/or compression parameters. For example, based on the target compression scheme (e.g., HEVC) and a target compression parameter (e.g., QP), the frame skipping processing module 310 may select a distance prediction model trained based on the corresponding compression scheme and corresponding compression parameter among a plurality of pre-trained distance prediction models. The target compression scheme and parameter may be compression scheme and compression parameter used by the encoder (e.g., encoder 113) to encode the frames.

According to an embodiment, the distance prediction model may be trained based on a pre-collected training data set. A method of collecting training data for training the distance prediction model will be described later with reference to FIGS. 8A and 8B. In the present disclosure, the training data set may also be referred to as a training dataset.

According to an embodiment, the rate-distortion curve may be associated with rate-distortion data (e.g., the first rate-distortion data 921 in FIG. 9) that includes bit rate and distortion values obtained based on a plurality of frames (e.g., frames 401, 402, and 403) to which frame skipping is not applied. For example, as illustrated in FIG. 8A, the rate-distortion curve 8010 may correspond to a curve that connects points each consisting of a pair of a bitrate value and a distortion value, obtained for each of a plurality of compression parameters (e.g., QP=0 to 51), based on the plurality of frames (e.g., frames 401, 402, and 403) to which frame skipping is not applied.

According to an embodiment, a target rate-distortion point may be associated with rate-distortion data (e.g., second rate-distortion data 922 of FIG. 9) including a bitrate value and a distortion value obtained based on a plurality of frames (e.g., frame 401 and frame 403 of FIG. 4) to which frame skipping is applied. For example, as illustrated in FIG. 8A, the target rate-distortion point (8001) may correspond to a point consisting of a pair of a bitrate value

$$( {R}_{t a r}^{Q p} )$$

and a distortion value

$$( {D}_{t a r}^{Q p} )$$

obtained for a target compression parameter (e.g., QP=n (0≤n≤51)) based on the plurality of frames (e.g., frame 401 and frame 403 of FIG. 4) to which frame skipping is applied.

According to an embodiment, the distance information may indicate the distance between the rate-distortion curve and the target rate-distortion point. For example, as shown in FIG. 8B, the distance 8020 may be the distance between the target rate-distortion point 8001 and a first line 8011 within the curve 8010 at the same bit rate

$$( {R}_{t a r}^{Q p} ) .$$

According to an embodiment, the distance may be calculated by the following equation:

$$distance = {D}_{tar}^{QP} - c ( {R}_{tar}^{QP} ) \qquad Equation 1$$

where c(rate) is a function corresponding to the first line 8011.

Such a distance may correspond to a difference in distortion between a case where frame skipping is applied and a case where frame skipping is not applied at the same bitrate. In the case where frame skipping is applied, the distortion may be obtained based on three original image frames, two image frames that are encoded and decoded corresponding thereto, and one image frame interpolated based on the two image frames, and the bitrate may be obtained based on the two image frames that are encoded and decoded. In the case where frame skipping is not applied, the distortion may be obtained based on three original image frames and three image frames that are encoded and decoded corresponding thereto, and the bitrate may be obtained based on the three image frames that are encoded and decoded. The distortion may be obtained, for example, using a preset method (e.g., a mean square error (MSE) method).

Meanwhile, according to an embodiment, the distance may correspond to a vertical distance between the first line 8011 and the target rate-distortion point 8001, rather than the distance calculated by Equation 1.

In operation 6030, the frame skipping processing module 310 may determine whether to apply frame skipping to a first frame (e.g., frame 402 of FIG. 4) based on the information on the obtained distance. For example, when the distance is calculated according to Equation 1, if the value of the distance is negative, the frame skipping processing module 310 may determine that frame skipping is to be applied to the first frame (e.g., frame 402 of FIG. 4). That is, in this case, the distortion when frame skipping is applied at the same bitrate is smaller than the distortion when frame skipping is not applied. For example, when the distance is calculated according to Equation 1, if the value of the distance is positive, the frame skipping processing module 310 may determine that frame skipping is not to be applied to the first frame (e.g., frame 402 of FIG. 4). That is, in this case, the distortion when frame skipping is applied at the same bitrate is greater than the distortion when frame skipping is not applied.

Hereinafter, with reference to FIG. 9, an algorithm (hereinafter, a frame skipping algorithm) for obtaining a distance corresponding to a difference in distortion between a case where frame skipping is applied and a case where frame skipping is not applied at the same bitrate will be described, and an example of a method for generating a training data set for training a distance prediction model for frame skipping processing based on the algorithm will be described.

FIG. 9 illustrates an example of a method for obtaining a distance between a rate-distortion curve and a target rate-distortion point according to an embodiment of the present disclosure.

In the embodiment of FIG. 9, the distance may be, for example, a distance (e.g., distance 8020 in FIG. 8B) between a rate-distortion curve (e.g., rate-distortion curve 8010 in FIG. 8A) and a target rate-distortion point (e.g., target rate-distortion point 8001 in FIG. 8B) at the same bitrate. Such a distance may be obtained using a frame skipping algorithm corresponding to a recursive algorithm as described below, but is not limited thereto.

Referring to FIG. 9, in operation 901, an image transmission device (e.g., image transmission device 110) may obtain a predetermined number (e.g., three or more) of frames. For example, the image transmission device may obtain three temporally consecutive frames.

In operation 902, the image transmission device may apply frame skipping to one of the obtained frames. For example, the image transmission device may skip the middle frame among the three obtained frames.

In operation 911, the image transmission device may perform first image processing on the obtained frames without applying frame skipping. For example, the image transmission device may perform encoding and decoding (i.e., general compression/decompression processing) on the three obtained frames without applying frame skipping. For instance, in the case where the compression method is HEVC and the compression parameter is QP, and the settable QP values range from 0 to 51, the image transmission device may perform encoding and decoding for each QP on the three obtained frames and thereby obtain data of first image-processed frames for each QP.

In operation 921, the image transmission device may obtain first rate-distortion data based on the data of the first image-processed frames for each QP. The first rate-distortion data may include a bitrate value and a distortion value obtained for each QP. That is, the first rate-distortion data may include

$$( {R}_{ref}^{0} , {D}_{ref}^{0} ) , … , ( {R}_{ref}^{Qp} , {D}_{ref}^{Qp} ) , … , ( {R}_{ref}^{51} , {D}_{ref}^{51} ) .$$

In an embodiment, the distortion value for each QP may correspond to an MSE (mean square error) value obtained based on the original frames and the first image-processed frames according to the corresponding QP.

In operation 912, the image transmission device may perform second image processing on the frames to which frame skipping is applied. For example, the image transmission device may perform encoding, decoding, and post-processing (e.g., frame interpolation and quality enhancement) on the two frames to which frame skipping is applied. For example, when the compression method is HEVC and the target compression parameter is QP, the image transmission device may perform encoding, decoding, and post-processing on the two frames for the target QP, and obtain data of the second image-processed frames corresponding to the target QP.

In operation 922, the image transmission device may obtain second rate-distortion data based on the data of the second image-processed frames for the target QP. The second rate-distortion data may include a bitrate value and a distortion value obtained for the target QP. That is, the second rate-distortion data may include

$$( {R}_{tar}^{Q p} , {D}_{tar}^{Q p} ) .$$

In an embodiment, the distortion value for the target QP may correspond to an MSE value obtained based on the original frames and the second image-processed frames according to the target QP.

In operation 930, the image transmission device may obtain distance data based on the first rate-distortion data and the second rate-distortion data.

According to an embodiment, the image transmission device may display the rate-distortion curve on a rate-distortion plane based on the first rate-distortion data. For example, as illustrated in FIG. 8A, the image transmission device may display the rate-distortion points

$$( e . g . , ( {R}_{ref}^{0} , {D}_{ref}^{0} ) , … , ( {R}_{ref}^{Qp} , {D}_{ref}^{Qp} ) , … , ( {R}_{ref}^{51} , {D}_{ref}^{51} ) )$$

included in the first rate-distortion data on the rate-distortion plane and connect the points to represent a rate-distortion curve (e.g., rate-distortion curve 8010 of FIG. 8A).

In an embodiment, the image transmission device may display a target rate-distortion point on the rate-distortion plane based on the second rate-distortion data. For example, as illustrated in FIG. 8A, the image transmission device may display the rate-distortion point

$$( e . g . , ( {R}_{tar}^{Q p} , {D}_{tar}^{Q p} ) )$$

included in the second rate-distortion data as a target rate-distortion point (e.g., target rate-distortion point 8001).

In an embodiment, the image transmission device may acquire distortion and bitrate values for QP (0, 51) and a target QP, i.e.,

$$[ {D}_{ref}^{0} , {D}_{ref}^{Q} , {D}_{ref}^{51} ] and [ {R}_{ref}^{0} , {R}_{ref}^{Q} , {R}_{ref}^{51} ] .$$

Then, the image transmission device may determine whether the bitrate

$${R}_{tar}^{Q p}$$

belongs to either of the intervals

$$[ {R}_{ref}^{0} , {R}_{ref}^{Q} ] or [ {R}_{ref}^{Q} , {R}_{ref}^{51} ] .$$

For example, when

$${R}_{ref}^{Q} < {R}_{tar}^{Q} and {R}_{tar}^{Q} < {R}_{ref}^{51} , and {R}_{t a r}^{Q p}$$

belongs to the interval

$$[ {R}_{ref}^{Q} , {R}_{ref}^{51} ] ,$$

the image transmission device may set again three QPs

$$[ Q , \frac{Q + 51}{2} , 51 ]$$

by using the midpoint between both QPs, 0 and 51. The image transmission device may recursively repeat the above process until the QPs [Q₁, Q₂] on both sides become consecutive values. When the QPs [Q₁, Q₂] on both sides become consecutive, the image transmission device may acquire

$$[ {D}_{ref}^{{Q}_{1}} , {D}_{ref}^{{Q}_{2}} ] and [ {R}_{ref}^{{Q}_{1}} , {R}_{ref}^{{Q}_{2}} ] for QPs [ {Q}_{1} , {Q}_{2} ] ,$$

interpolate them as a straight line, and obtain a function C(rate) of the line (e.g., line 8011 of FIG. 8B). The image transmission device may then calculate the distance to the target point (i.e., the target rate-distortion point

$$( {R}_{tar}^{Q} , {D}_{tar}^{Q} ) )$$

using, for example, Equation 1. As described above, the distance may correspond to the difference in distortion at the same bitrate. For example, when the distance is negative, the target point

$$[ {D}_{tar}^{Q} , {R}_{tar}^{Q} ]$$

may exhibit lower distortion at the same bitrate. Conversely, when the distance is positive, the target point

$$[ {D}_{tar}^{Q} , {R}_{tar}^{Q} ]$$

may exhibit higher distortion at the same bitrate.

Meanwhile, by changing the target QP to each of the settable QPs and repeatedly performing the above-described operations of FIG. 9 for each target QP, the distance corresponding to each target QP may be obtained. In addition, for all available frames, the operations of FIG. 9 may be repeatedly performed by grouping them into sets of a predetermined number of frames (e.g., three), as described above.

However, when using the frame skipping algorithm of FIG. 9 as described above, the image transmission device must repeatedly perform the same procedure for multiple QPs in order to obtain a distance value for a frame set at a target QP, which results in a long encoding time. Accordingly, instead of directly using the frame skipping algorithm of FIG. 9 to obtain the distance, it may be more useful to train an artificial intelligence model (e.g., distance prediction model 7010 of FIG. 7) for each QP using a dataset obtained via the frame skipping algorithm of FIG. 9, and to use the trained AI model for each QP. For example, the three frames may be input as input data to a distance prediction model associated with a QP, and the distance prediction model may be trained such that the output distance value (first distance value) of the distance prediction model becomes equal to a distance value (second distance value) associated with the QP corresponding to the three frames, which has been previously known via the frame skipping algorithm of FIG. 9. Meanwhile, the training of the artificial intelligence model may be performed by the image transmission device, or it may be performed by another electronic device (e.g., a server), and the trained artificial intelligence model (or at least one parameter associated with the artificial intelligence model) may be transmitted to the image transmission device.

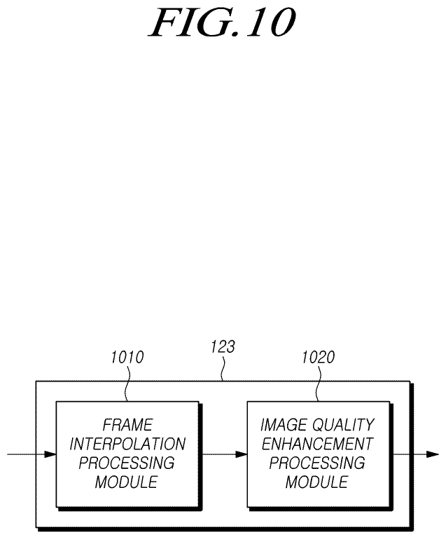

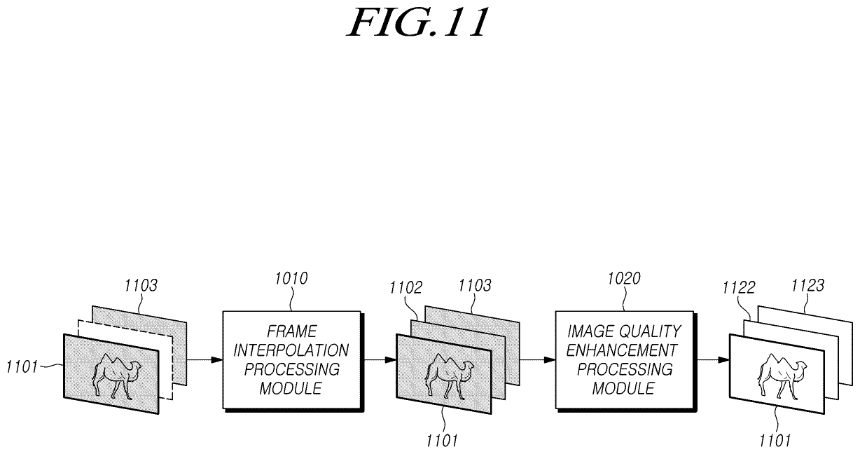

FIG. 10 illustrates a frame interpolation processing module and a quality enhancement processing module of a post-processing unit according to an embodiment of the present disclosure. FIG. 11 schematically illustrates operations of frame interpolation processing module and quality enhancement processing module according to an embodiment of the present disclosure.

Referring to FIG. 10, the post-processing unit 123 may include a frame interpolation processing module 1010 for frame interpolation processing and an image quality enhancement processing module 1020 for image quality enhancement processing. In the present disclosure, the operations of the frame interpolation processing module 1010 and the image quality enhancement processing module 1020 may be understood as operations performed by at least one processor of the image transmission device 120 and/or the image reception device 120.

According to an embodiment, the frame interpolation processing module 1010 may perform frame interpolation processing on a decoded video signal. For example, the frame interpolation processing module 1010 may interpolate one frame using a plurality of decoded frames. As illustrated in FIG. 11, the frame interpolation processing module 1010 may interpolate a frame 1102 between two input frames 1101 and 1103. The interpolated frame 1102 may correspond to a temporally intermediate frame between the frames 1101 and 1103.

According to an embodiment, the interpolated frame 1102 may correspond to a frame (e.g., frame 402 in FIG. 4) skipped by the frame skipping processing module (e.g., frame skipping processing module 310 in FIG. 3) of the image transmission device. Thereafter, the frame interpolation processing module 1010 may deliver the frames 1101, 1102, and 1103 (including the interpolated frame 1102) to the image quality enhancement processing module 1020.

According to an embodiment, the frame interpolation processing module 1010 may determine whether to apply frame interpolation to a corresponding frame set based on information related to frame skipping received from the image transmission device. If it is determined to apply frame interpolation to the frame set, the frame interpolation processing module 1010 may interpolate one frame (first frame, e.g., frame 1102 in FIG. 11) between a plurality of frames included in the frame set, and provide the frame set including the interpolated first frame to the image quality enhancement processing module 1020. If it is determined not to apply frame interpolation to the frame set, the frame interpolation processing module 1010 may provide the frame set without interpolation of the first frame to the image quality enhancement processing module 1020. Alternatively, if frame interpolation is not applied to the frame set, image quality enhancement processing by the image quality enhancement processing module 1020 may also be omitted.

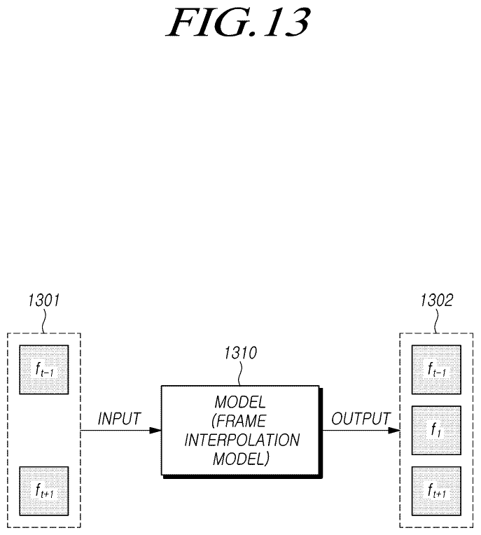

According to an embodiment, the frame interpolation processing module 1010 may perform frame interpolation processing on a decoded video signal using a pre-trained AI model (hereinafter referred to as a frame interpolation model). A detailed description of the frame interpolation model and its training method will be provided below with reference to FIG. 13.

According to an embodiment, the image quality enhancement processing module 1020 may perform image quality enhancement processing on either frame-interpolated or non-interpolated video signals. For example, the image quality enhancement processing module 1020 may perform image quality enhancement processing on frame-interpolated video signals. As illustrated in FIG. 11, the image quality enhancement processing module 1020 may perform image quality enhancement processing on the frame-interpolated frames 1101, 1102, and 1103, and generate quality-enhanced frames 1121, 1122, and 1123.

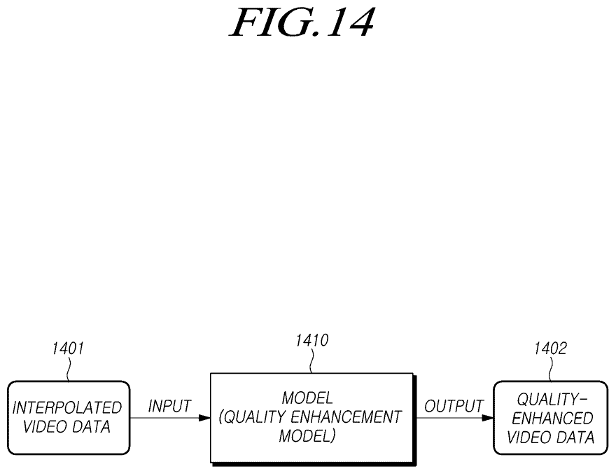

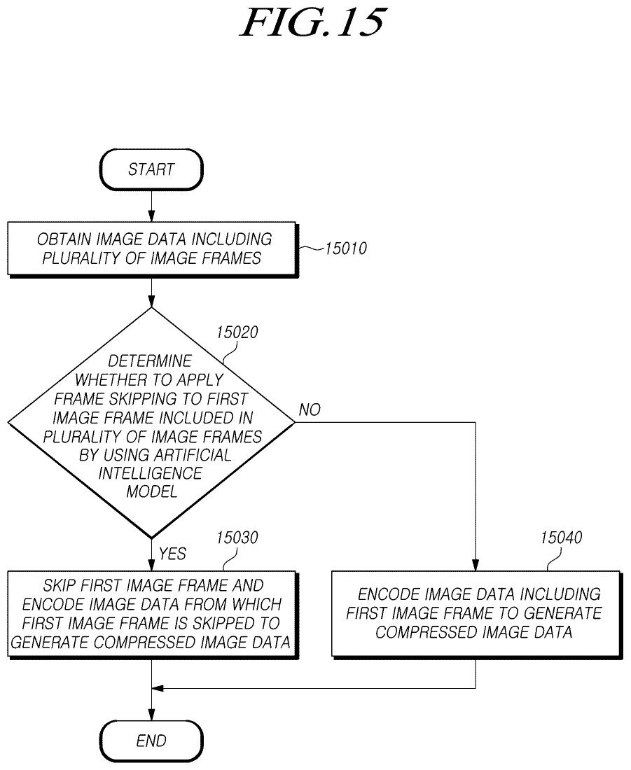

According to an embodiment, the image quality enhancement processing module 1020 may perform image quality enhancement using a pre-trained model (hereinafter referred to as a quality enhancement model). The image quality enhancement process using the quality enhancement model will be described below with reference to FIG. 14.

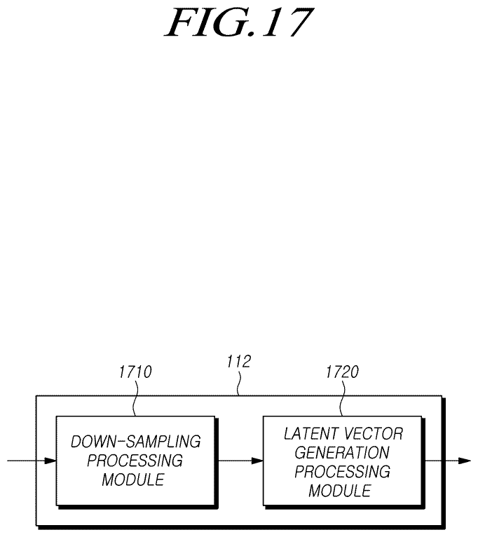

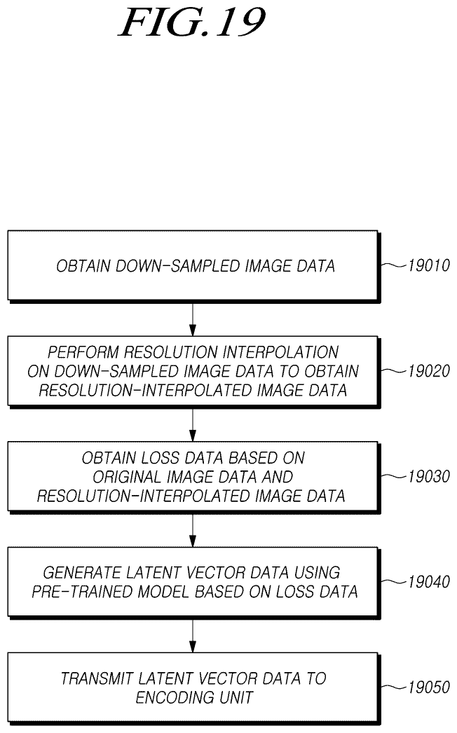

According to an embodiment, the image quality enhancement processing module 1020 may be, or may include, a GoP enhancement processing module (e.g., GoP enhancement processing module 1910 in FIG. 19). The GoP enhancement processing module may perform GoP enhancement processing on either frame-interpolated or non-interpolated video signals. Details of the GoP enhancement processing module will be described below with reference to FIGS. 17 to 23.

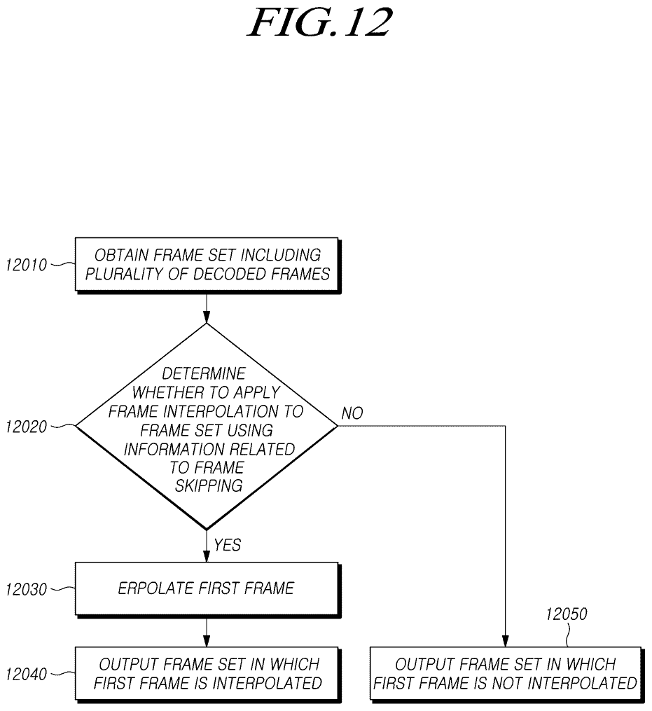

Below, with reference to FIG. 12, exemplary operations of a frame interpolation method performed by the frame interpolation processing module 1010 will be described.

FIG. 12 is a flowchart of a frame interpolation processing method according to an embodiment of the present disclosure. FIG. 13 shows an example of a model for frame interpolation processing according to an embodiment of the present disclosure.

The operations of the frame interpolation processing module 1010 described below may be controlled or performed by at least one processor of the image transmission device 110 and/or the image reception device 120.

Referring to FIG. 12, in operation 12010, the frame interpolation processing module 1010 may obtain a frame set including a plurality of decoded frames. For example, as illustrated in FIG. 11, the frame interpolation processing module 1010 may obtain a frame set including a decoded frame 1101 and a decoded frame 1103.

In operation 12020, the frame interpolation processing module 1010 may determine whether to apply frame interpolation to the frame set using information related to frame skipping. For example, the frame interpolation processing module 1010 may decide whether to apply frame interpolation based on whether the frame skipping-related information indicates that a frame within the frame set has been skipped. If the information indicates that a frame has been skipped, the frame interpolation processing module 1010 may determine to apply interpolation to the corresponding frame. If the information indicates that no frame has been skipped, the frame interpolation processing module 1010 may determine not to apply interpolation to the corresponding frame.

In operation 12030, if it is determined to apply frame interpolation to the frame set, the frame interpolation processing module 1010 may interpolate one frame between the plurality of frames included in the frame set. For example, as illustrated in FIG. 11, the frame interpolation processing module 1010 may interpolate (or generate) a first frame 1102 at the midpoint in time between frames 1101 and 1103 using frames 1101 and 1103 in the frame set.

According to an embodiment, the frame interpolation processing module 1010 may interpolate the first frame using a pre-trained model (frame interpolation model) based on the plurality of frames in the frame set. For example, as illustrated in FIG. 13, the frame interpolation processing module 1010 may input a frame set 1301 including the decoded frames (e.g., frames 1101 and 1103 of FIG. 11) into the model 1310 as input data, and obtain a frame set 1302 including the interpolated first frame as output data. In the present disclosure, the model 1310 may be referred to as the frame interpolation model.

According to an embodiment, the frame interpolation model may be an artificial intelligence model including a plurality of artificial neural network layers. The neural network may be, for example, a DNN, CNN, RNN, RBM, DBN, BRDNN, deep Q-network, or any combination of two or more of the above, but is not limited thereto.

According to an embodiment, the frame interpolation model may include an input layer, one or more hidden layers, and an output layer. According to an embodiment, the frame interpolation model may include an input layer, a plurality of convolutional layers, fully connected layers, and an output layer.

According to an embodiment, the frame interpolation model may be trained based on a dataset obtained through an algorithm using similarity considering a time or (or, a time axis) (i.e., time domain) of the video. In contrast, when trained on a dataset obtained using an algorithm based on motion vectors of the video, it may be difficult to achieve accurate interpolation for degraded videos, because the motion vectors extracted from compressed/restored (or encoded/decoded) videos may be distorted. However, this issue can be addressed when the frame interpolation model is trained using a dataset derived from an algorithm that considers the similarity considering a time axis of the video.

Meanwhile, the dataset for training the frame interpolation model may include not only datasets without compression/restoration (or, encoded/decoded)-induced degradation but also datasets that have undergone such degradation. This allows the frame interpolation model to be trained even for degraded video.

In operation 12040, the frame interpolation processing module 1010 may output a frame set including the interpolated first frame 1102. For example, the module may deliver the frame set including the interpolated frame 1102 to the image quality enhancement processing module 1020.

In operation 12050, if it is determined not to apply frame interpolation to the frame set, the frame interpolation processing module 1010 may output the frame set in which the first frame 1102 is not interpolated.

FIG. 14 shows an example of a model for quality enhancement processing according to an embodiment of the present disclosure.

The operations of the quality enhancement processing module 1020 described below may be controlled or performed by at least one processor of the image transmission device 110 and/or the image reception device 120.

Referring to FIG. 14, the quality enhancement processing module 1020 may input interpolated video data 1401 (e.g., video data including frames 1101, 1102, and 1103 of FIG. 11) into the model 1410 as input data and obtain quality-enhanced video data 1402 (e.g., video data including frames 1121, 1122, and 1123 of FIG. 11) as output data. In the present disclosure, the model 1410 may be referred to as the quality enhancement model.

According to an embodiment, the quality enhancement model may be an artificial intelligence model including a plurality of artificial neural network layers. The neural network may be, for example, a DNN, CNN, RNN, RBM, DBN, BRDNN, deep Q-network, or any combination of two or more of these, but is not limited thereto.

According to an embodiment, the quality enhancement model may include an input layer, one or more hidden layers, and an output layer. According to an embodiment, the quality enhancement model may include an input layer, a plurality of convolutional layers, fully connected layers, and an output layer.

According to an embodiment, the quality enhancement model may be trained based on a dataset obtained through an algorithm for quality enhancement that considers the time (or, time axis) of the video.

Meanwhile, since the quality enhancement processing is performed not only after compression/restoration (or encoding/decoding) processing, but also after frame interpolation processing, the dataset for training the quality enhancement model may include both datasets degraded due to compression/restoration (or encoding/decoding) and datasets degraded due to frame interpolation. That is, the quality enhancement model may be trained as an end-to-end network that performs frame interpolation and quality enhancement jointly.

FIG. 15 is a flowchart of an image processing method of an image transmission device according to an embodiment of the present disclosure.

Referring to FIG. 15, the image transmission device (e.g., the image transmission device 110 shown in FIGS. 1 and 2A/B) may obtain image data including a plurality of image frames (15010).

The image transmission device may determine whether to apply frame skipping to a first image frame among the plurality of image frames by using an artificial intelligence (AI) model (or a frame skipping algorithm) (15020).

If it is determined that frame skipping is to be applied to the first image frame, the image transmission device may skip the first image frame and encode the image data from which the first image frame is skipped to generate compressed image data (15030).

If it is determined that frame skipping is not to be applied to the first image frame, the image transmission device may encode image data including the first image frame to generate compressed image data (15040).

The image transmission device may transmit the compressed image data and/or information related to the frame skipping.

According to an embodiment, the image transmission device may select an AI model from among a plurality of AI models based on parameters for encoding the image data.

According to an embodiment, the image transmission device may encode the image data in which the first image frame is skipped using the encoding parameters to generate compressed image data.

According to an embodiment, the encoding parameters (e.g., quantization parameter (QP)) may be associated with the compression ratio of the image data.

According to an embodiment, the AI model is configured to output a distance corresponding to a difference between a first distortion and a second distortion at the same bitrate. The first distortion may be associated with a first image frame set in which frame skipping is applied to the first image frame, and the second distortion may be associated with a second image frame set in which frame skipping is not applied to the first image frame.

According to an embodiment, the first image frame set may include a second image frame (preceding the first image frame) and a third image frame (succeeding the first image frame). The second image frame set may include the first image frame, the second image frame, and the third image frame.

According to an embodiment, to determine whether to apply frame skipping to the first image frame, the image transmission device may encode and decode the first image frame, the second image frame, and the third image frame, input the encoded and decoded frames into the AI model as input data, obtain a distance value as output data from the AI model, and determine whether to apply frame skipping to the first image frame based on the distance.

According to an embodiment, to determine whether to apply frame skipping to the first image frame, the image transmission device may input the first image frame, the second image frame, and the third image frame (without encoding and decoding) directly into the AI model as input data, obtain the distance as output data from the AI model, and determine whether to apply frame skipping to the first image frame based on the distance.

According to an embodiment, the distance may correspond to a value obtained by subtracting the second distortion from the first distortion.

According to an embodiment, based on the distance, the image transmission device may determine that frame skipping is to be applied to the first image frame if the distance is negative, and that frame skipping is not to be applied if the distance is positive.

According to an embodiment, the AI model is trained based on a plurality of training datasets. Each training dataset may be obtaining by performing the following operations: obtaining an image frame set, performing first image processing on the image frame set for each configurable value of the encoding parameter to obtain first rate-distortion data, performing second image processing on a frame-skipped image frame set for a target parameter value of encoding to obtain second rate-distortion data, and obtaining a distance based on the first and second rate-distortion data.

In an embodiment, the first image processing may include encoding and decoding processes. The second image processing may include encoding, decoding, frame interpolation, and quality enhancement processes.

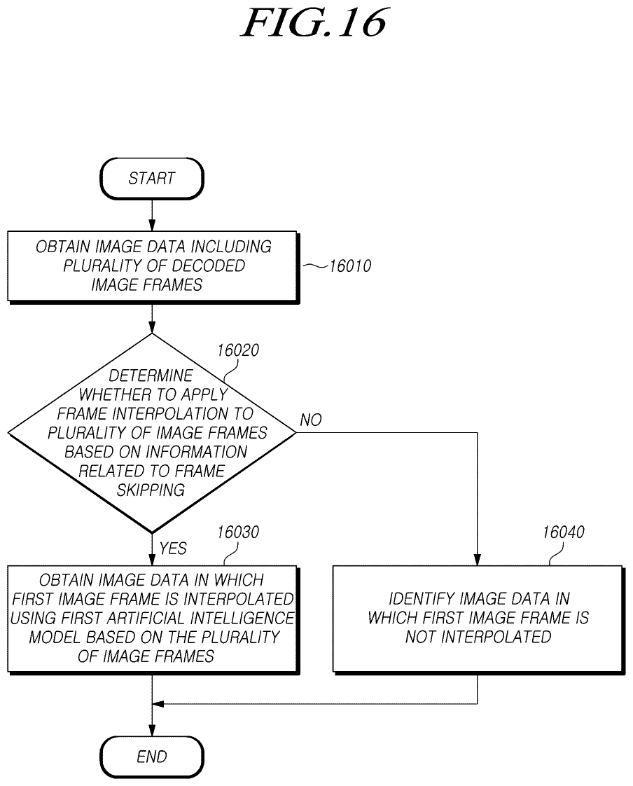

FIG. 16 is a flowchart of an image processing method of an image reception device according to an embodiment of the present disclosure.

Referring to FIG. 16, the image reception device (e.g., the image reception device 120 shown in FIGS. 1 and 2A/B) may obtain image data including a plurality of decoded image frames (16010).

The image reception device may determine whether to apply frame interpolation to the plurality of image frames based on information related to frame skipping (16020).

If it is determined that frame interpolation is to be applied to the plurality of image frames, the image reception device may use a first artificial intelligence (AI) model to generate image data in which a first image frame has been interpolated based on the plurality of image frames (16030).

If it is determined that frame interpolation is not to be applied, the image reception device may identify image data in which the first image frame has not been interpolated (16040).

According to an embodiment, the image reception device may use a second AI model to obtain enhanced image data based on the image data in which the first image frame has been interpolated.

According to an embodiment, the information related to frame skipping may be set to either a first value indicating that frame skipping has been applied to the first image frame, or a second value indicating that frame skipping has not been applied to the first image frame.

According to an embodiment, to determine whether to apply frame interpolation, the image reception device may determine to apply frame interpolation when the frame skipping information is set to the first value, and may determine not to apply frame interpolation when the information is set to the second value.

According to an embodiment, the plurality of image frames may include a second image frame preceding the first image frame and a third image frame following the first image frame.

According to an embodiment, to generate interpolated image data of the first image frame using the first AI model, the image reception device may input the second and third image frames as input data to the first AI model and obtain, as output data, the image data in which the first image frame has been interpolated.

According to an embodiment, the first AI model may be trained based on a dataset obtained through an algorithm using similarity considering the temporal axis of video frames.

Below, a pre-processing method using latent vector techniques—which compress and represent the loss information caused by techniques for reducing original video size and/or quality (e.g., down-scaling or down-sampling techniques)—and a post-processing method using resolution enhancement techniques (e.g., super-resolution) will be described.

According to an embodiment, the image transmission device may reduce the size and/or quality of an original video (e.g., high-resolution video) by down-sampling, and then compress the down-sampled video (e.g., low-resolution video), thereby reducing the compression volume.

According to an embodiment, the image transmission device may compress loss information caused by down-sampling into a latent vector using a latent vector technique. For example, the latent vector technique may be implemented via an AI model (e.g., a deep learning-based AI model). The latent vector, which contains compressed loss information, is compressed and transmitted along with the video to the image reception device and can, by the image reception device, be used to enhance the resolution of the down-sampled video. Compared to compressing and transmitting the original high-resolution video as itself, using a down-sampled low-resolution video combined with the latent vector providing loss information may be more efficient in terms of both compression rate and video quality.

According to an embodiment, the image reception device may restore the video using a super-resolution technique based on the down-scaled video and the latent vector containing the loss information. The super-resolution technique may also be implemented using an AI model (e.g., a deep learning-based AI model). The restored video may be of substantially the same quality as the original video or, in some cases, even higher quality than the original.

The following describes, with reference to the accompanying drawings, an exemplary preprocessing method using the aforementioned down-scale technique and latent vector technique, and a postprocessing method using a super-resolution technique for resolution enhancement.

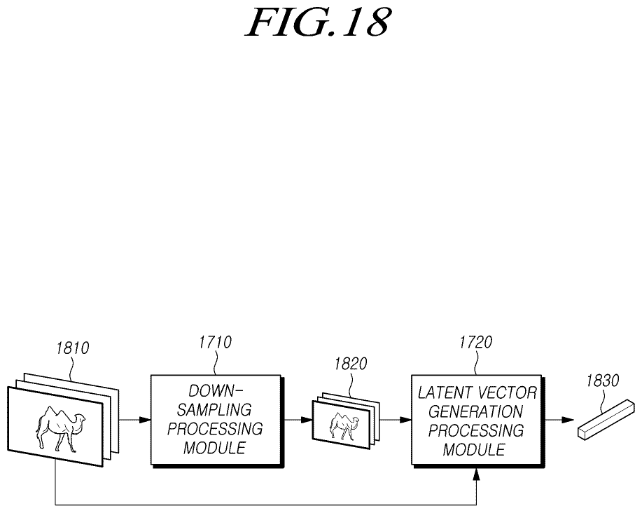

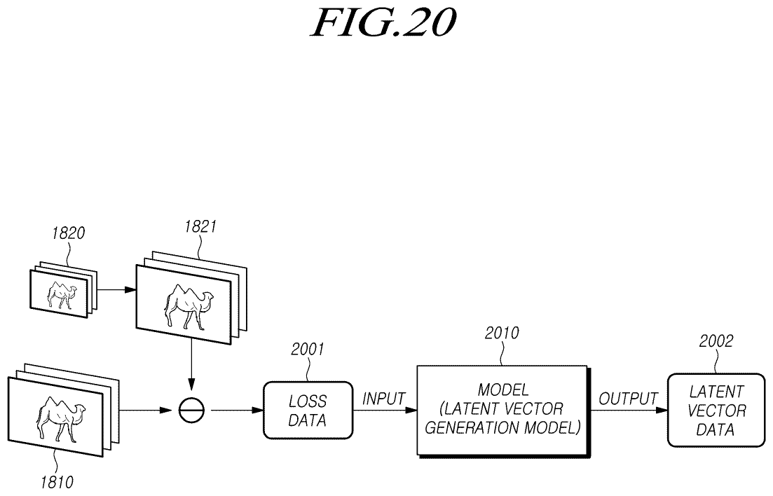

FIG. 17 illustrates a down-sampling processing module and a latent vector generation processing module of a pre-processing unit according to an embodiment of the present disclosure. FIG. 18 schematically illustrates operations of down-sampling processing module and latent vector generation processing module according to an embodiment of the present disclosure. FIG. 19 is a flowchart of a latent vector generation method according to an embodiment of the present disclosure. FIG. 20 shows an example of a model for latent vector generation processing according to an embodiment of the present disclosure.

Referring to FIG. 17, the preprocessing unit 112 may include a down-sampling processing module 1710 for down-scaling (or down-sampling) an image, and a latent vector generation processing module 1720 for generating a latent vector that provides loss information of the image. In the present disclosure, the operations of the down-sampling processing module 1710 and the latent vector generation processing module 1720 may be controlled or performed by at least one processor of the image transmission device 110 and/or the image reception device 120. Meanwhile, depending on the embodiment, the latent vector generation processing module 1720 may not be included in the pre-processing unit 112 of FIG. 2a or the pre-processing unit 112a of FIG. 2b, but may instead be included in the latent vector processing unit 115a of FIG. 2b.

According to an embodiment, the down-sampling processing module 1710 may down-sample image data including at least one frame and generate down-sampled image data. For example, as illustrated in FIG. 18, the down-sampling processing module 1710 may down-sample original image data 1810 including at least one original frame, and generate down-sampled image data 1820. The down-sampled image data 1820 may include at least one down-sampled frame, and each down-sampled frame may be a frame whose size, quality, and/or resolution is reduced compared to the corresponding original frame. For example, a down-sampled frame may be a frame reduced to one-quarter of the size of the original frame.

According to an embodiment, the down-sampling processing module 1710 may extract important information (e.g., ¼ of the information) from the original image data using a frame selection technique, and obtain the down-sampled image data using the extracted important information. For example, the down-sampling processing module 1710 may remove information other than the extracted important information to obtain the down-sampled image data (e.g., image data with ¼ the size of the original image data).

The down-sampling processing module 1710 may transmit the down-sampled image data to an encoding unit (e.g., the encoding unit 113 of FIG. 2a or the codec processing unit 113a of FIG. 2b), and the encoding unit may encode the down-sampled image data. The encoded image data may be transmitted to an image reception device (e.g., the image reception device 120 of FIG. 2a or 2b). This down-sampling may reduce compression size and save transmission traffic. Meanwhile, information on the loss caused by down-sampling (loss information) may be transmitted to the image reception device through the latent vector, which will be described later, and the image reception device may use the latent vector to enhance the quality of the down-sampled image.

According to an embodiment, the latent vector generation processing module 1720 may generate latent vector data based on the original image data and the down-sampled image data.

For example, as illustrated in FIG. 18, the latent vector generation processing module 1720 may generate latent vector data 1830 based on the original image data 1810 including at least one original frame and the down-sampled image data 1820 including at least one down-sampled frame. The latent vector data 1830 may provide information (loss information) on the loss caused by down-sampling.

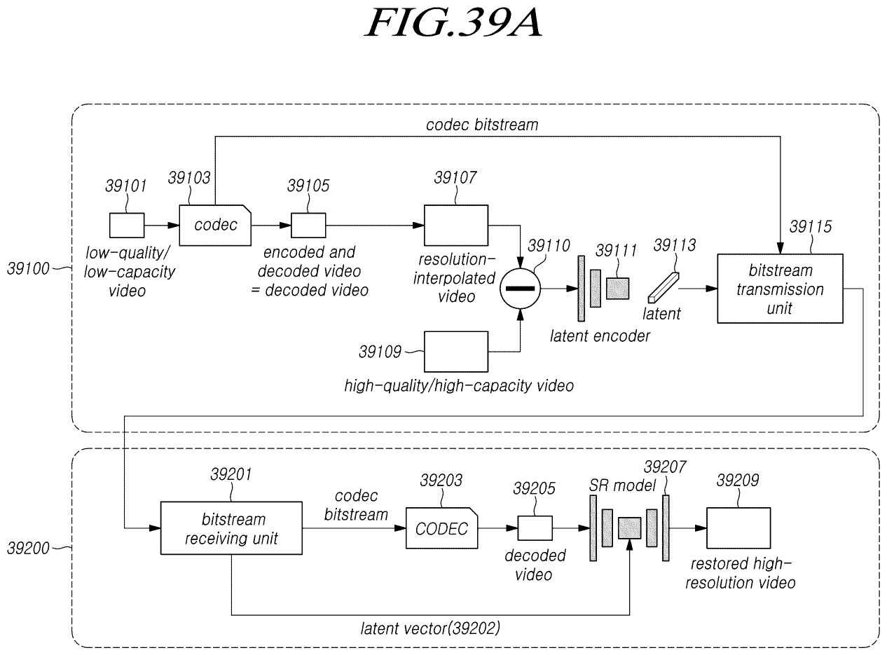

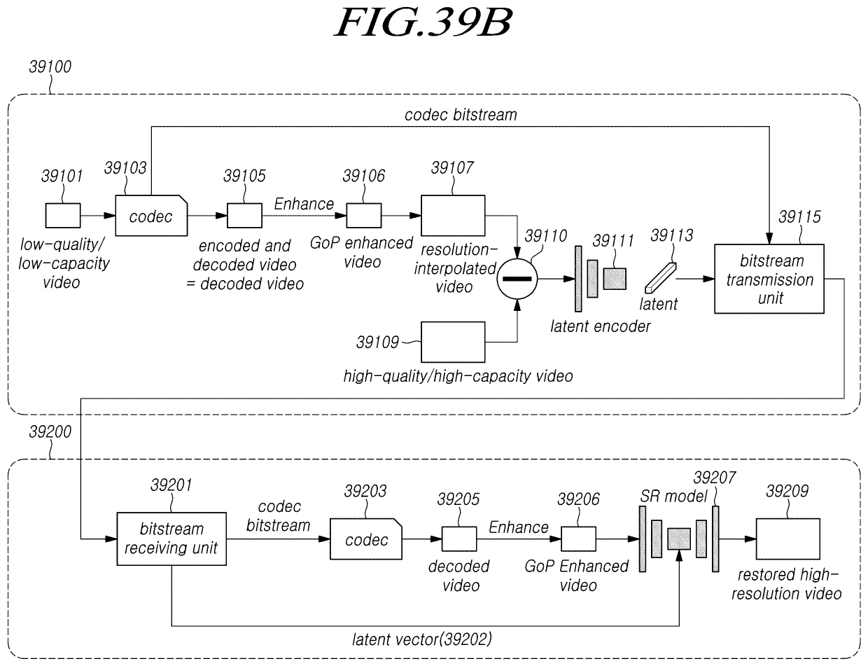

For instance, as illustrated in FIG. 39A, the latent vector generation processing module 1720 may generate latent vector data 39113 based on compressed and degraded image data 39105, which is generated by encoding and decoding processing 39103 of the original image data 39109 (including at least one original frame) and the down-sampled image data 39101 (including at least one down-sampled frame) by the codec processing unit (e.g., codec processing unit 113a of FIG. 2b).

According to an embodiment, the latent vector generation processing module 1720 may generate one latent vector per frame, but is not limited thereto. For example, one latent vector may be generated for multiple frames, or multiple latent vectors may be generated for one frame.

According to an embodiment, the latent vector generation processing module 1720 may use a pre-trained AI model to generate the latent vector data. For example, based on the original image data 1810 including at least one original frame and the down-sampled image data 1820 including at least one down-sampled frame, the latent vector generation processing module 1720 may generate latent vector data 1830 using a pre-trained AI model. In the present disclosure, the AI model used to generate the latent vector may be referred to as a latent vector generation model or a latent encoder model.

According to an embodiment, the latent vector generation model may be an artificial intelligence model including a plurality of artificial neural network layers. The artificial neural network may be, for example, a DNN, CNN, RNN, RBM, DBN, BRDNN, deep Q-network, or a combination of two or more of the above, but is not limited thereto.

According to an embodiment, the latent vector generation model may include an input layer, one or more hidden layers, and an output layer. According to an embodiment, the latent vector generation model may include an input layer, a plurality of convolutional layers, fully connected layers, and an output layer.

Meanwhile, the latent vector generation model may be trained based on a pre-obtained dataset.

With reference to FIG. 19, exemplary operations of the latent vector generation method of the latent vector generation processing module 1720 will be described. These operations may be controlled or performed by at least one processor of the image transmission device 110 and/or the image reception device 120. In the present disclosure, the term “down-sampled image data” may refer to image data generated by the down-sampling processing module 1710 (e.g., the image data in FIG. 18 or the image data 39101 in FIG. 39A), or image data obtained by encoding and decoding the down-sampled image data (e.g., the image data 39105 in FIG. 39A).

Referring to FIG. 19, in operation 19010, the latent vector generation processing module 1720 may obtain down-sampled image data (e.g., the image data 1820 of FIG. 18 or the image data 39105 of FIG. 39A). For example, as shown in FIG. 18, the module may obtain down-sampled image data 1820 including a plurality of down-sampled frames (e.g., three or four frames).

In operation 19020, the latent vector generation processing module 1720 may perform resolution interpolation on the down-sampled image data to obtain resolution-interpolated image data (e.g., image data 1821 in FIG. 20 or 39107 in FIG. 39A). For example, as illustrated in FIG. 20, the latent vector generation processing module 1720 may generate resolution-interpolated image data 1821 including a plurality of resolution-interpolated frames based on the resolution interpolation on the down-sampled image data 1810 including the plurality of the down-sampled frames. The resolution-interpolated frames have the same size as the original frames.

According to an embodiment, the latent vector generation processing module 1720 may use a predetermined interpolation method (e.g., bicubic interpolation) to perform the resolution interpolation on the down-sampled image data.

In operation 19030, the latent vector generation processing module 1720 may obtain loss data based on the original image data (e.g., image data 1810 in FIG. 20 or 39109 in FIG. 39A) and the resolution-interpolated image data. For example, as illustrated in FIG. 20, the latent vector generation processing module 1720 may obtain loss data 2001 based on the difference between the original image data 1810 including a plurality of original frame and the resolution-interpolated image data 1821 including a plurality of resolution-interpolated frame.

According to an embodiment, the latent vector generation processing module 1720 may calculate the difference in a predetermined unit (e.g., pixel unit) for a frame pair consisting of an original frame (e.g., a first frame) and its corresponding resolution-interpolated frame (e.g., a frame obtained by down-sampling and resolution interpolating the first frame, and obtain the loss data for the frame pair. Such pixel-level difference calculation may be performed for each frame pair, respectively. The overall loss data obtained through this method may include loss data for each frame pair.

In operation 19040, the latent vector generation processing module 1720 may generate latent vector data (e.g., latent vector data 2002 in FIG. 20 or 39113 in FIG. 39A) using a pre-trained model (e.g., model 2010 in FIG. 20 or model 39111 in FIG. 39A) based on the loss data. For example, as illustrated in FIG. 20, the latent vector generation processing module 1720 may input the loss data 2001 of multiple frame pairs into the latent vector generation model 2010 (or a latent encoder including the model 2010). The latent vector generation processing module 1720 may obtain the latent vector data 2002 output from the model 2010. Thus, pixel-level differences (loss information) for each frame pair can be compressed into latent vectors. The obtained latent vector data may include compressed information of the pixel-level differences (loss information) for each frame pair. As the latent vector data includes compressed information rather than the loss information itself, its size is smaller than the loss information. This reduces compression size. Furthermore, as the latent vector data includes the loss information, it can be used by the image reception device to restore the information lost due to down-sampling.

In operation 19050, the latent vector generation processing module 1720 may transmit the generated latent vector data to the encoding unit. The latent vector data transmitted to the encoding unit may be encoded (or compressed) along with the down-sampled image data and transmitted to the image reception device. As one embodiment, the encoded latent vector data may be added to a bitstream that includes encoded video data. For example, a first bitstream generated by encoding the latent vector data (e.g., by quantizing the latent vector data and applying entropy coding) may be included in a certain region of a second bitstream generated by encoding the video data. For example, the first bitstream may be included in the description region of the second bitstream, although this is not limiting. The description region may be a region for describing the information and structure of the bitstream. Meanwhile, depending on the embodiment, operation 19050 may be omitted. For example, when the latent vector generation processing module 1720 is included in the latent vector processing unit 115a of FIG. 2b, the latent vector generated by the latent vector generation processing module 1720 may be directly transmitted to the image output unit (e.g., image output unit 114a of FIG. 2b) without being encoded by the codec processing unit (e.g., 113a of FIG. 2b).

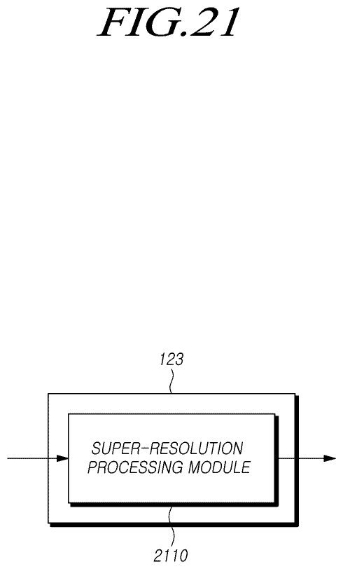

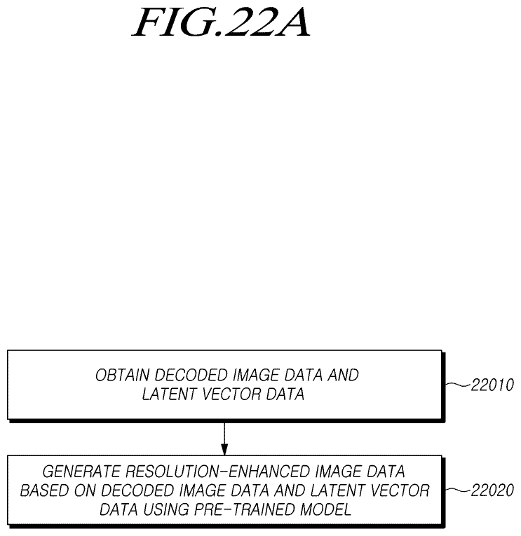

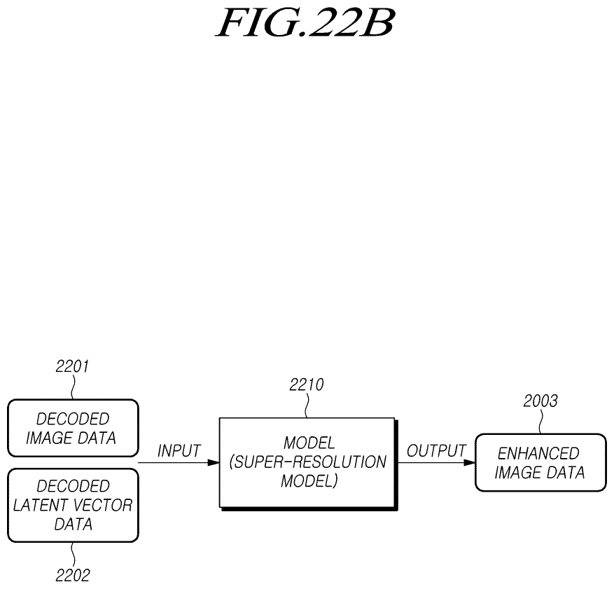

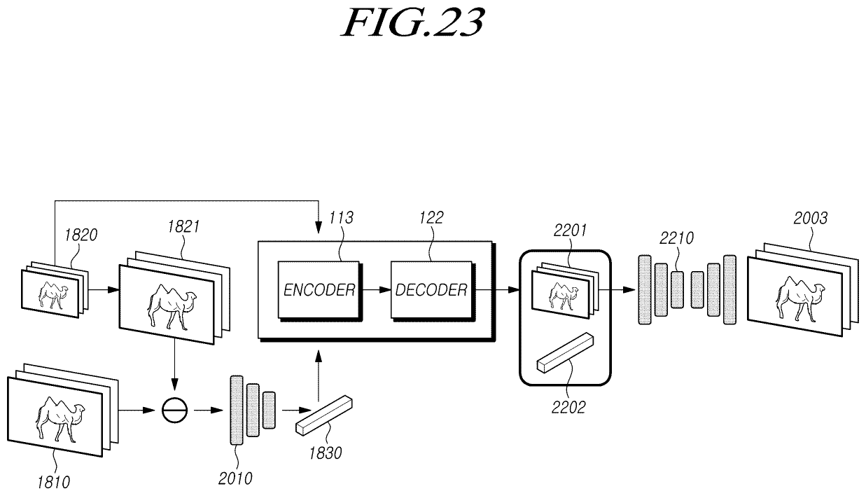

FIG. 21 illustrates a super-resolution processing module of a post-processing unit according to an embodiment of the present disclosure. FIG. 22A illustrates an operation of super-resolution processing module according to an embodiment of the present disclosure. FIG. 22B shows an example of a model for super-resolution processing according to an embodiment of the present disclosure.

Referring to FIG. 21, the post-processing unit 123 may include a super-resolution processing module 2110 for performing resolution enhancement processing. According to an embodiment, the super-resolution processing module 2110 may perform processing to enhance the quality (e.g., resolution) of decoded image signals.

Referring to FIG. 22A, in operation 22010, the super-resolution processing module 2110 may obtain decoded image data and latent vector data (e.g., latent vector data decoded by the decoder 122 of FIG. 2a or latent vector data delivered by the image input unit 121a of FIG. 2a).

According to an embodiment, as illustrated in FIG. 23, the decoder (e.g., decoder 122 of FIG. 1b) may decode the received image data and latent vector data, and deliver the decoded image data (e.g., image data 2201 of FIG. 23) and the decoded latent vector data (e.g., latent vector data 2202 of FIG. 23) to the super-resolution processing module 2110. In this case, the super-resolution processing module 2110 may obtain the decoded image data and decoded latent vector data delivered from the decoder 122.

According to an embodiment, as illustrated in FIG. 39A, the decoder (e.g., codec processing unit 122a of FIG. 2b) may decode the received image data and deliver the decoded image data (e.g., image data 39205 of FIG. 39A) to the super-resolution processing module (e.g., SR model 39207 of FIG. 39A), and the image input unit (e.g., image input unit 121a of FIG. 2b) may deliver the received latent vector data to the super-resolution processing module (e.g., SR model 39207 of FIG. 39A). In this case, the super-resolution processing module 39207 may obtain the decoded image data delivered from the codec processing unit 122a and the latent vector data delivered from the image input unit 121a.

In operation 22020, the super-resolution processing module 2110 may generate resolution-enhanced image data based on the decoded image data and the latent vector data (or decoded latent vector data), using a pre-trained model (hereinafter referred to as a super-resolution (SR) model).

For example, as illustrated in FIGS. 22B and 23, the super-resolution processing module 2110 may input the decoded image data 2201 and the decoded latent vector data 2202 as input data to the model 2210, and obtain enhanced image data 2003 as output data.

For example, as illustrated in FIG. 39A, the super-resolution processing module 39207 may input the decoded image data 39205 and (non-decoded) latent vector data as input data to the model 39207 and obtain enhanced image data 39209 as output data.

According to an embodiment, the super-resolution model may be composed of a vision transformer-based encoder and decoder. In this case, the latent vector data may act between the encoder and decoder to provide additional information (e.g., loss information) for restoring the image. Through this, the restored image may have the same size as the original image.

According to an embodiment, the super-resolution model may be an artificial intelligence model including a plurality of artificial neural network layers. The artificial neural network may be, for example, a DNN, CNN, RNN, RBM, DBN, BRDNN, deep Q-network, or a combination of two or more of the above, but is not limited thereto.

According to an embodiment, the super-resolution model may include an input layer, one or more hidden layers, and an output layer. According to an embodiment, the super-resolution model may include an input layer, a plurality of convolutional layers, fully connected layers, and an output layer.

Meanwhile, since the super-resolution processing is performed after latent vector processing and compression/restoration processing, the dataset for training the super-resolution model includes not only datasets degraded by latent vector processing but also datasets degraded by compression/restoration. That is, the super-resolution model may be trained in an end-to-end manner together with the entire network including latent vector generation and compression/restoration processing.

FIG. 23 illustrates an example of an image processing procedure according to an embodiment of the present disclosure.

The image processing procedure in FIG. 23 may be an example of an image processing procedure using a latent vector technique for pre-compression processing and a super-resolution technique for post-restoration processing. For example, the image processing procedure may be an example of an image processing procedure using a latent vector generation processing module (e.g., latent vector generation processing module 1710 of FIG. 17) and a super-resolution processing module (e.g., super-resolution processing module 2110 of FIG. 21).

Referring to FIG. 23, the image transmission apparatus (e.g., image transmission apparatus 110 of FIGS. 1 and 2A/2B) may obtain original image data 1810 including at least one original frame.

According to an embodiment, the image transmission apparatus may perform down-sampling on the original image data 1810 (e.g., original image data including a plurality of frames such as a first frame, a second frame, and a third frame) to obtain down-sampled image data 1820 (e.g., down-sampled image data including a plurality of down-sampled frames such as a first down-sampled frame, a second down-sampled frame, and a third down-sampled frame).

According to an embodiment, the image transmission apparatus may perform resolution interpolation on the down-sampled image data 1820 to obtain resolution-interpolated image data 1821 (e.g., resolution-interpolated image data including a plurality of resolution-interpolated frames such as a first resolution-interpolated frame, a second resolution-interpolated frame, and a third resolution-interpolated frame).

According to an embodiment, the image transmission apparatus may obtain loss data based on the original image data 1810 and the resolution-interpolated image data 1821. For example, the image transmission apparatus may compute a difference in a predetermined unit (e.g., pixel unit, although not limited thereto) between a frame pair composed of an original frame in the original image data 1810 and a resolution-interpolated frame corresponding to the original frame in the resolution-interpolated image data 1821 (e.g., a frame pair composed of the first frame and the first resolution-interpolated frame obtained by down-sampling and interpolating the first frame), to obtain the loss data for the corresponding frame pair. In this manner, the loss data for all frame pairs may be obtained.

According to an embodiment, the image transmission apparatus may input the loss data to a latent vector generation model (or a latent encoder including the latent vector generation model) 2010, and obtain latent vector data 1830 output from the latent vector generation model (or the latent encoder) 2010.

According to an embodiment, the image transmission apparatus may input the down-sampled image data 1820 and the latent vector data 1830 to the encoder 113, and transmit the encoded image data and the encoded latent vector data output from the encoder 113 to the image reception apparatus (e.g., image reception apparatus 120 of FIG. 2). As an example, the encoded latent vector data may be appended to a bitstream including the encoded image data.

According to an embodiment, the image reception apparatus may receive the encoded image data and the encoded latent vector data and deliver them to the decoder 122. The image reception apparatus may obtain the decoded image data 2201 and the decoded latent vector data 2202 output from the decoder 122.

According to an embodiment, the image reception apparatus may input the decoded image data 2201 and the decoded latent vector data 2202 to the SR model 2210, and obtain enhanced image data 2003 output from the SR model 2210. The frames included in the enhanced image data 2003 thus obtained may have substantially the same quality as the frames included in the original image data 1810.

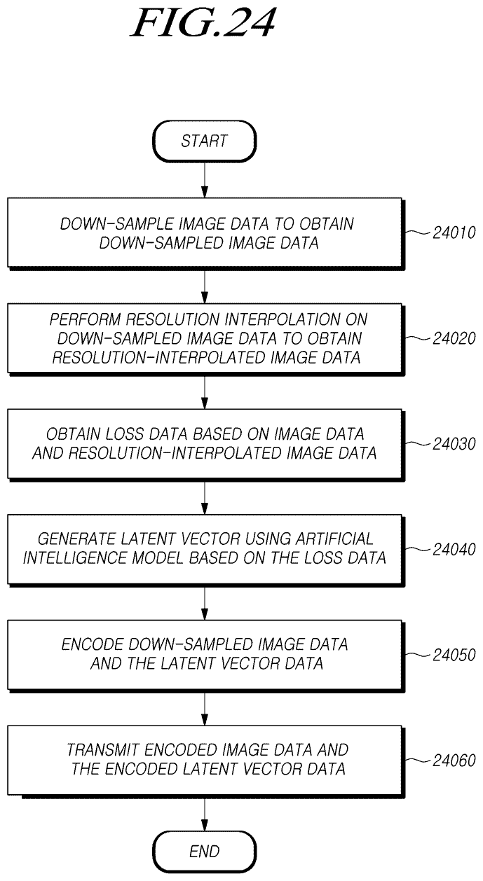

FIG. 24 is a flowchart illustrating an image processing method of an image transmission apparatus according to an embodiment of the present disclosure.

Referring to FIG. 24, the image transmission apparatus (e.g., image transmission apparatus 110 of FIG. 2) may down-sample image data (e.g., image data 1810 of FIG. 23 or image data 39109 of FIG. 39A) to obtain down-sampled image data (e.g., image data 1820 of FIG. 23 or image data 39105 of FIG. 39A) (24010).

The image transmission apparatus may perform resolution interpolation on the down-sampled image data to obtain resolution-interpolated image data (e.g., image data 1821 of FIG. 23 or image data 39107 of FIG. 39A) (24020).

The image transmission apparatus may obtain loss data (e.g., loss data 2001 of FIG. 23 or loss data 39110 of FIG. 39A) based on the image data and the resolution-interpolated image data (24030).

The image transmission apparatus may generate latent vector data (e.g., latent vector data 2002 of FIG. 23 or latent vector data 39113 of FIG. 39A) using an artificial intelligence model (e.g., model 2010 of FIG. 23 or model 39111 of FIG. 39A) based on the loss data (24040).

The image transmission apparatus may encode the down-sampled image data and/or the latent vector data (24050). For example, as illustrated in FIG. 23, the image transmission apparatus may encode the down-sampled image data 1820 and the latent vector data 2002 using the encoder 113. For example, as illustrated in FIG. 39A, the image transmission apparatus may encode the down-sampled image data 39101 using the encoder 113a, and may not encode the latent vector data 39113.

The image transmission apparatus may transmit the encoded image data and/or the encoded latent vector data (24050). For example, as illustrated in FIG. 23, the image transmission apparatus may transmit the encoded image data and the encoded latent vector data to the image reception apparatus. For example, as illustrated in FIG. 39A, the image transmission apparatus may transmit the encoded image data 39101 and the (non-encoded) latent vector data to the image reception apparatus.

According to an embodiment, in order to obtain the loss data, the image transmission apparatus may calculate a difference in a predetermined unit for a frame pair composed of a first frame included in the image data and a second frame corresponding to the first frame and included in the resolution-interpolated image data, thereby obtaining the loss data.

According to an embodiment, the predetermined unit may correspond to a pixel unit.

According to an embodiment, to obtain the resolution-interpolated image data, the image transmission apparatus may perform resolution interpolation on the down-sampled image data using a bicubic interpolation method.

According to an embodiment, the image transmission apparatus may generate a bitstream including the encoded image data and the encoded latent vector data by encoding the down-sampled image data and the latent vector data using a standardized codec technique.

According to an embodiment, the image transmission apparatus may include a step of transmitting the bitstream including the encoded image data and the encoded latent vector data.

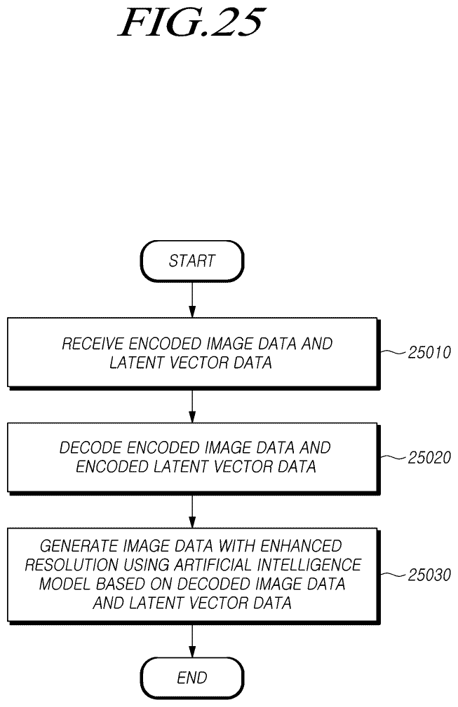

FIG. 25 is a flowchart of an image processing method of an image reception device according to an embodiment of the present disclosure.

Referring to FIG. 25, the image reception apparatus (e.g., image reception apparatus 120 of FIG. 2) may receive encoded image data and latent vector data (e.g., the encoded latent vector data of FIG. 23 or the (non-encoded) latent vector data of FIG. 39A) (25010).

The image reception apparatus may decode the encoded image data and/or the encoded latent vector data (25020). For example, as illustrated in FIG. 23, the image reception apparatus may decode the encoded image data and encoded latent vector data using the decoder 122. For example, as illustrated in FIG. 39A, the image reception apparatus may decode the encoded image data using the decoder 122a and deliver the latent vector data to the SR model 39207 without decoding.

The image reception apparatus may generate image data with enhanced resolution (e.g., image data 2003 of FIG. 23 or image data 39209 of FIG. 39A) using an artificial intelligence model (e.g., model 2210 of FIG. 23 or model 39207 of FIG. 39A) based on the decoded image data and the latent vector data (e.g., the decoded latent vector data 2201 of FIG. 23 or the latent vector data 39202 of FIG. 39A) (25030).

According to an embodiment, the latent vector data is generated based on loss data used for restoring the decoded image data, and the image reception apparatus may obtain the loss data by calculating differences in a predetermined unit for associated frame pairs.

According to an embodiment, the predetermined unit may correspond to a pixel unit.

According to an embodiment, the artificial intelligence model may be composed of a vision transformer-based encoder and decoder.

According to an embodiment, the image reception apparatus may receive a bitstream including the encoded image data and the encoded latent vector data.

According to an embodiment, the image reception apparatus may decode the encoded image data and the encoded latent vector data using a standardized codec technique.

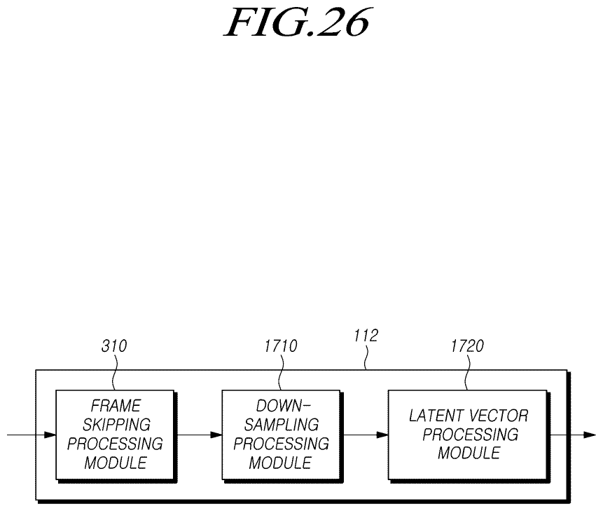

Meanwhile, the embodiments described in FIGS. 3 to 16 (i.e., the first embodiment related to frame skipping, frame interpolation, and quality enhancement technologies) and the embodiments described in FIGS. 17 to 25 (i.e., the second embodiment related to down-sampling, latent vector, and SR technologies) may be combined with each other as long as no contradictions arise. For example, for pre-processing before compression (encoding), frame skipping, down-sampling, and/or latent vector technologies may be used in combination; and for post-processing after restoration (decoding), frame interpolation, quality enhancement, and SR technologies may be used in combination. Hereinafter, an example of such a combined embodiment will be described. However, this is merely an example, and the respective technologies may be combined in various sequences and manners. Meanwhile, contents that are identical to those described in FIGS. 3 to 25 may be referred to in FIGS. 26 to 28.

FIG. 26 illustrates an example configuration of a pre-processing unit according to an embodiment of the present disclosure.

Referring to FIG. 26, the pre-processing unit 112 (or the image transmission apparatus (e.g., image transmission apparatus 100 of FIG. 1)) may include a frame skipping processing module 310, a down-sampling processing module 1710, and a latent vector processing module 1720. In an embodiment, the operation of the frame skipping processing module 310 may be performed prior to the operations of the down-sampling processing module 1710 and the latent vector processing module 1720, but is not limited thereto. The description of the frame skipping processing module 310 may refer to the description of FIGS. 3 to 16 above. The descriptions of the down-sampling processing module 1710 and the latent vector processing module 1720 may refer to the descriptions of FIGS. 17 to 25 above. Meanwhile, according to an embodiment, the latent vector processing module 1720 may not be included in the pre-processing unit 112, but may be included in a latent vector processing unit (e.g., latent vector processing unit 115a of FIG. 2b) of the image transmission apparatus.

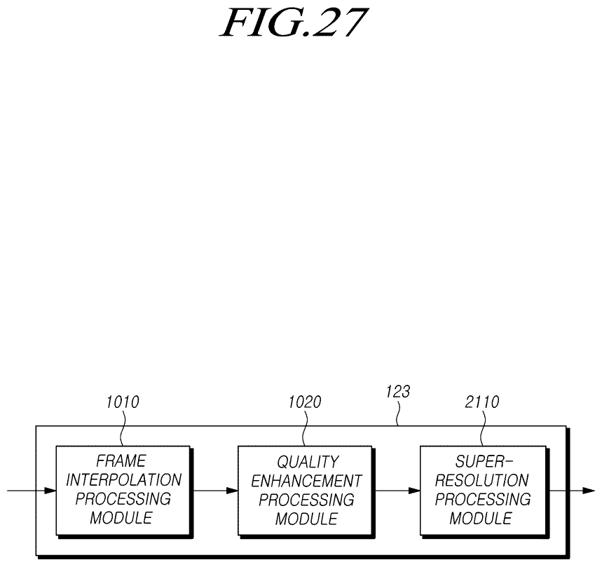

FIG. 27 illustrates an example configuration of a post-processing unit according to an embodiment of the present disclosure.

Referring to FIG. 27, the post-processing unit 123 may include a frame interpolation processing module 1010, a quality enhancement processing module 1020, and a super-resolution processing module 2110.

In an embodiment, the operation of the super-resolution processing module 2110 may be performed after the operations of the frame interpolation processing module 1010 and the quality enhancement processing module 1020, but is not limited thereto. The descriptions of the frame interpolation processing module 1010 and the quality enhancement processing module 1020 may refer to the descriptions of FIGS. 3 to 16 above. The description of the super-resolution processing module 2110 may refer to the descriptions of FIGS. 17 to 25 above.

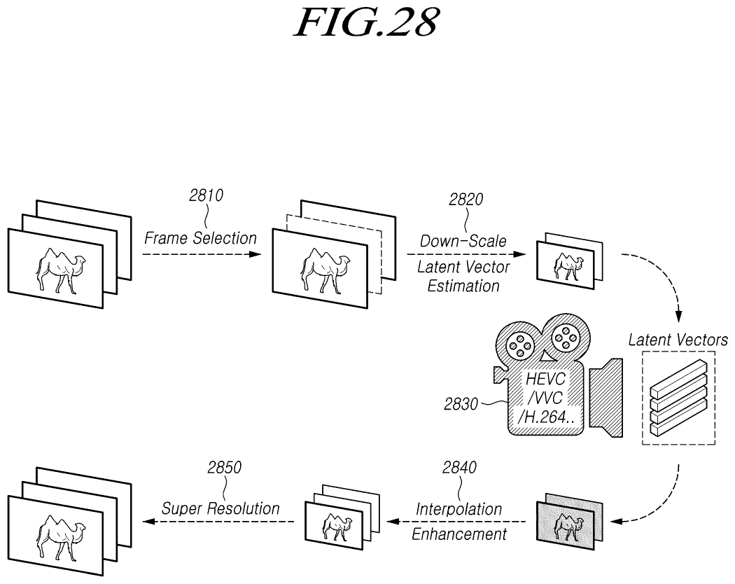

FIG. 28 illustrates an example of an image processing procedure according to an embodiment of the present disclosure.

In the embodiment of FIG. 28, it is assumed that the operation of the frame skipping processing module (e.g., frame skipping processing module 310 of FIG. 3) is performed prior to the operations of the down-sampling processing module (e.g., down-sampling processing module 1710 of FIG. 17) and the latent vector processing module (e.g., latent vector processing module 1720 of FIG. 17), and the operation of the super-resolution processing module (e.g., super-resolution processing module 2110 of FIG. 21) is performed after the operations of the frame interpolation processing module (e.g., frame interpolation processing module 1010 of FIG. 10) and the quality enhancement processing module (e.g., quality enhancement processing module 1020 of FIG. 10). However, the embodiment is not limited thereto, and the reverse order is also possible.

Referring to FIG. 28, the image transmission apparatus (e.g., image transmission apparatus 110 of FIGS. 1, 2A, and 2B) may obtain original image data including at least one original frame.

According to an embodiment, the image transmission apparatus may perform a frame selection operation (or frame skipping operation) to obtain frame-skipped image data (2810). The description of the frame skipping operation may refer to the descriptions of FIGS. 3 to 9 and FIG. 15.

According to an embodiment, the image transmission apparatus may perform a downscale operation (or down-sampling operation) and a latent vector estimation operation (or latent vector generation operation) to generate downscaled image data and latent vector data (2820). For example, the down-sampling operation may be performed prior to the latent vector generation operation. The descriptions of the down-sampling operation and the latent vector generation operation may refer to the descriptions of FIGS. 17 to 20 and FIG. 24.

According to an embodiment, the image transmission apparatus may encode the downscaled image data and/or the latent vector data using, for example, a standardized codec technique (e.g., HEVC, VVC, H.264), and transmit the encoded image data and latent vector data (or encoded latent vector data) to the image reception apparatus (e.g., image reception apparatus 120 of FIGS. 1, 2A, and 2B), and the image reception apparatus may receive the encoded image data and latent vector data (or encoded latent vector data) and decode the encoded image data and/or the encoded latent vector data (2830).

According to an embodiment, the image reception apparatus may perform an interpolation operation (or frame interpolation operation) and an enhancement operation (or quality enhancement operation) on the decoded image data to obtain image data with interpolated/enhanced frames (2840). For example, the frame interpolation operation may be performed prior to the quality enhancement operation, but is not limited thereto. The descriptions of the frame interpolation operation and the quality enhancement operation may refer to the descriptions of FIGS. 10 to 14 and FIG. 16.

According to an embodiment, the image reception apparatus may perform a super-resolution operation on the image data with interpolated/enhanced frames using the latent vector data (or decoded latent vector data) to obtain image data with enhanced resolution (2850). The description of the super-resolution operation may refer to the descriptions of FIGS. 21 to 23 and FIG. 25. The final image data thus obtained may provide substantially the same quality as the original image data.

Hereinafter, a post-processing method using GoP enhancement processing according to the present disclosure will be described.

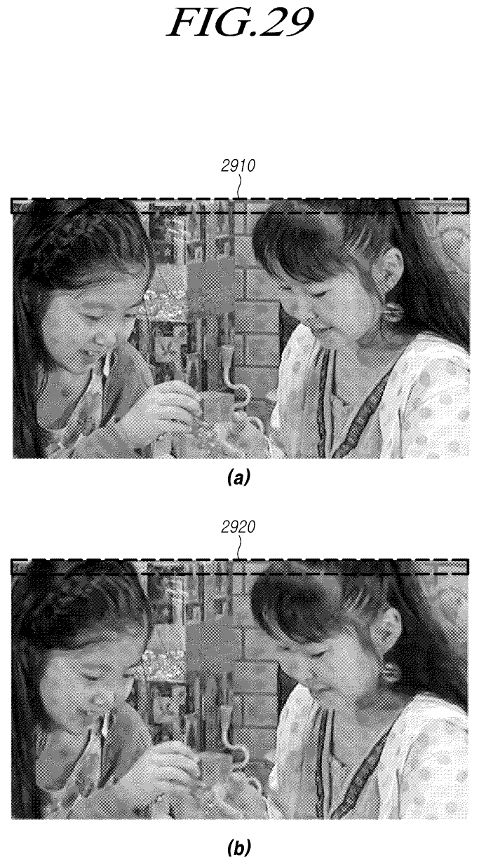

FIG. 29 illustrates original video and encoded video according to an embodiment of the present disclosure.

Part (a) of FIG. 29 shows an example of an original image. Referring to part (a) of FIG. 29, the original image may include a first region 2910.

Part (b) of FIG. 29 shows an example of a decoded image that is generated by an image receiving apparatus (e.g., the image receiving apparatus 120 of FIG. 1, 2A, or 2B) which receives an encoded image generated by encoding the original image of part (a) of FIG. 29 and then decodes the encoded image. Referring to part (b) of FIG. 29, the encoded and decoded image may include a second region 2920 corresponding to the first region 2910 of the original image. The first region 2910 and the second region 2920 may be areas representing the same spatial region in the frame of the original image and the frame of the encoded/decoded image, respectively. In the present disclosure, the encoded and decoded image may also be referred to as a codec-processed image generated by a codec processing unit (e.g., codec processing unit 113a or 122a in FIG. 1c).

According to an embodiment, the encoding process for the original image may be performed by an encoding unit of the image transmitting apparatus (e.g., the encoding unit 113 of the image transmitting apparatus 110 in FIGS. 1 and 2A, or the codec processing unit 113a of the image transmitting apparatus 110 in FIG. 2B). The decoding process for the encoded image may be performed by a decoding unit of the image receiving apparatus (e.g., the decoding unit 122 of the image receiving apparatus 120 in FIGS. 1 and 2A, or the codec processing unit 122a of the image receiving apparatus 120 in FIG. 2B).

According to an embodiment, the image transmitting apparatus (or encoding unit) may perform encoding on a unit basis of a frame group including at least one reference frame (e.g., an I-frame). The frame group may include a sequence of consecutive frames including one reference frame. The reference frame may be used to compress (or encode) other frames within the frame group. For example, the frame group may correspond to a Group of Pictures (GoP).

According to an embodiment, the image transmitting apparatus (or encoding unit) may compress (or encode) the frames within the frame group (or, GoP) based on a single reference frame within the frame group (or, GoP). In this manner, video compression (or encoding) may be performed on a frame group (or, GoP) basis. Since video compression on the frame group (or, GoP) is performed based on a reference frame within the frame group (or, GoP), degradation due to compression/decompression may occur on a frame group (or, GoP) basis.

Hereinafter, for convenience of explanation, it is assumed that the unit of encoding (or compression) is a GoP, and embodiments of the present disclosure will be described based on this assumption. However, it will be apparent that the embodiments of the present disclosure are equally applicable to any frame group that performs the same function/role as the GoP.

According to an embodiment, a GoP may include various types of frames. For example, a GoP may include I-frames (intra-coded frames), P-frames (predictive-coded frames), and/or B-frames (bi-predictive-coded frames).

According to an embodiment, an I-frame may be a frame encoded independently without reference to other frames. An I-frame may include a complete image at a specific point in a video sequence. In the present disclosure, the I-frame may also be referred to as a reference frame or a key frame.

According to an embodiment, a P-frame may be a frame predictively encoded based on a previously encoded I-frame or P-frame. A P-frame may be encoded using difference information with respect to an I-frame or another P-frame.

According to an embodiment, a B-frame may be a frame predictively encoded based on both previous and subsequent frames. A B-frame is located between I-frames and P-frames and may be encoded by utilizing as much difference information as possible.

According to an embodiment, the GoP may include an I-frame as its first frame, and when the GoP includes two or more frames, the GoP may further include at least one B-frame and/or at least one P-frame. For example, if the size of the GoP is 12, it may have a GoP pattern such as IBPPPPBBPBBP.

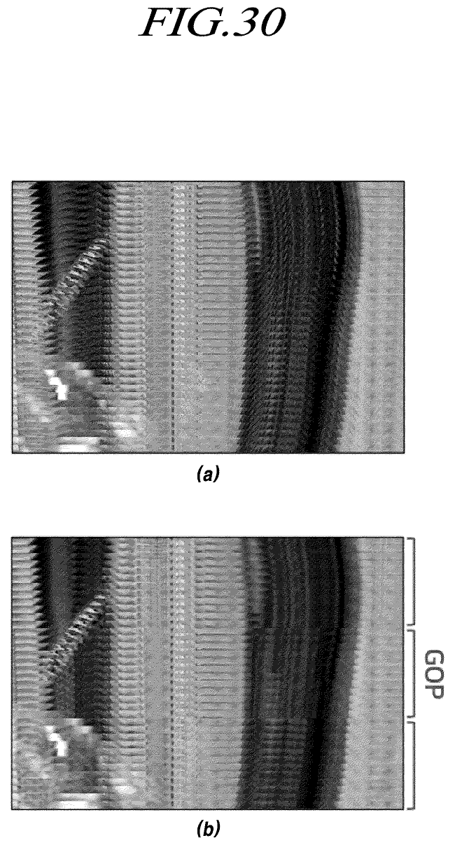

According to an embodiment, the I-frame, as the first frame in the GoP, may be compressed using image compression (e.g., intra compression or intra-frame compression), since there is no frame to refer to. However, the remaining frames in the GoP may be compressed using video compression (e.g., inter compression or inter-frame compression), referring to other adjacent frames. For example, if the GoP consists of 12 frames, the first frame may be intra-compressed, and the remaining 11 frames may be inter-compressed. In this case, the 11 frames are successively compressed by referring to the first frame. Therefore, distortion occurring during compression of the first frame may be propagated to the subsequent 11 frames. This results in distortion in the later frames within the GoP. Hereinafter, with reference to FIG. 30, an example of distortion occurring within a GoP will be described.

FIG. 30 illustrates an image displaying first part of original video in chronological order and an image displaying second part corresponding to first part of original video in chronological order according to an embodiment of the present disclosure.

Part (a) of FIG. 30 shows a first image in which the first region (e.g., the first region 2910 of the original video shown in part (a) of FIG. 29) is extracted from each frame of the original video and stacked vertically in temporal order from top to bottom.

Part (b) of FIG. 30 shows a second image in which the second region (e.g., the second region 2920 of the encoded and decoded video shown in part (b) of FIG. 29) is extracted from each frame of the encoded and decoded video and stacked vertically in temporal order from top to bottom.

Referring to part (a) of FIG. 30, in the case of the first image associated with the original video, it can be observed that changes in the image appear smooth over time.

In contrast, referring to part (b) of FIG. 30, in the case of the second image associated with the encoded and decoded video, it can be seen that changes in the image over time are not smooth. As shown, significant changes appear at GoP unit boundaries. That is, abrupt changes occur in the image at the boundaries of GoPs. This distortion occurs, as previously described, because the distortion caused by the compression of the first I-frame in a given GoP propagates to the following 11 frames, and the distortion caused by the compression of the second I-frame (which is different from the first I-frame) in the next GoP likewise propagates to the subsequent 11 frames. In other words, different distortions occur in the first I-frame of each GoP, and since the remaining frames of each GoP are compressed with reference to their corresponding I-frames, the distortion characteristics of the I-frames are propagated to those subsequent frames. Therefore, different distortion characteristics may exist between GoPs.

Meanwhile, various methods have been proposed to restore distortions caused by compression. However, such methods are primarily intended to maintain consistency within a single frame or temporal consistency between adjacent frames.

However, as described above, compression-induced distortion also occurs between GoPs (or frame groups). Accordingly, a new method needs to be considered to restore distortion occurring between GoPs. Hereinafter, a post-processing method using GoP enhancement processing is described to restore distortion (hereinafter referred to as GoP distortion) occurring between GoPs (e.g., between adjacent GoPs).

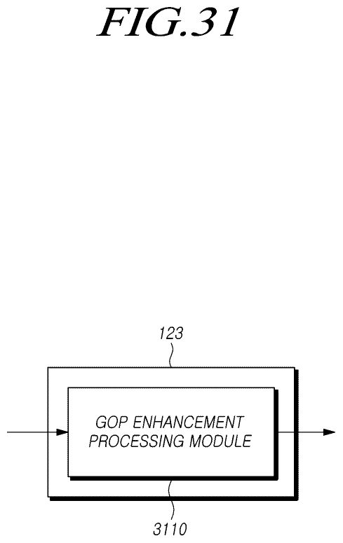

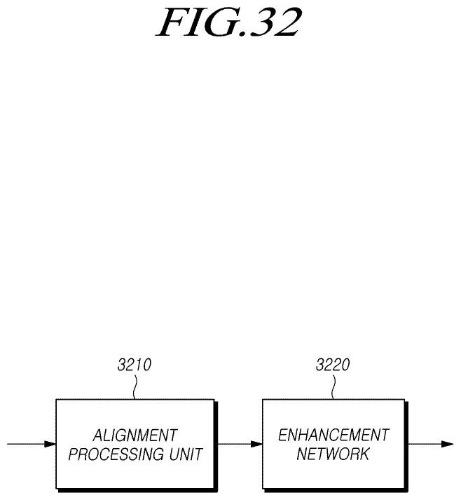

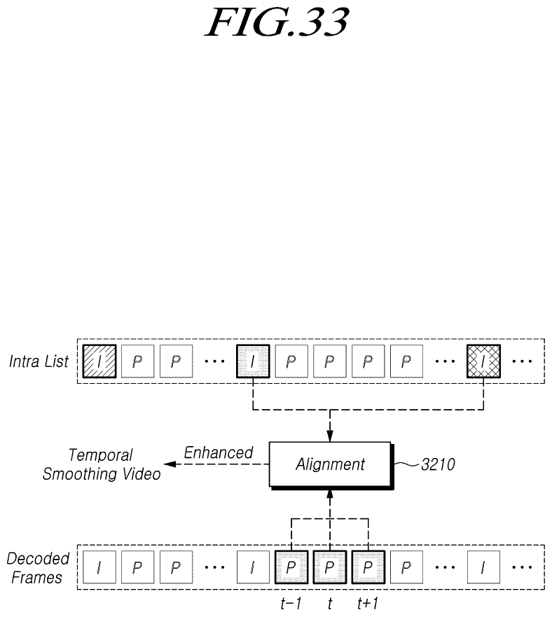

FIG. 31 illustrates a GoP enhancement processing module of a post-processing unit according to an embodiment of the present disclosure. FIG. 32 illustrates an operation of GoP enhancement processing module according to an embodiment of the present disclosure. FIG. 33 illustrates an example of a procedure for alignment processing of GoP enhancement processing module according to an embodiment of the present disclosure.

Referring to FIG. 31, the post-processing unit 123 may include a GoP enhancement processing module 3110 for quality enhancement. The frames input to the GoP enhancement processing module 3110 may correspond to frames decoded by a decoder 122 operating prior to the post-processing unit 123.

According to an embodiment, the GoP enhancement processing module 3110 may perform processing for enhancing the quality (e.g., restoration of GoP distortion) of a decoded video signal.

According to an embodiment, the GoP enhancement processing module 3110 may be an example of the quality enhancement processing module 1020.

According to an embodiment, the GoP enhancement processing module 3110 may restore frames in units of a preset number (e.g., 3) of frames. For example, the GoP enhancement processing module 3110 may perform processing for restoring GoP distortion in units of three frames and may restore the respective frames.

Hereinafter, the operations of the GoP enhancement processing module or components included in the GoP enhancement processing module may be understood as operations of the image reception device (e.g., the image reception device 120 of FIGS. 1 and 2A/B) or the post-processing unit (e.g., the post-processing unit 123 of the image reception device 120 of FIGS. 1 and 2A/B) of the image reception device.

Referring to FIG. 32, the GoP enhancement processing module 3110 may include an alignment processing unit 3210 and/or an enhancement network 3220. In the present disclosure, the enhancement network 3220 may be referred to as an enhancement model.

According to an embodiment, the alignment processing unit 3210 may perform at least one operation for alignment processing for frames (e.g., I-frames).

According to an embodiment, the alignment processing unit 3210 may obtain (or identify) a first frame of a first frame group and a second frame of a second frame group subsequent to the first frame group. For example, the first frame and the second frame may correspond to frames that are independently encoded and decoded. The first and second frames may each be a frame used for encoding (or compression) of at least one other frame within the corresponding frame group. For example, the first frame and the second frame may be I-frames. The second frame group may be a frame group immediately following the first frame group, i.e., adjacent to and located after the first frame group.

According to an embodiment, the alignment processing unit 3210 may perform processing to align the first frame with a plurality of consecutive frames (e.g., three consecutive frames) in the first frame group, and may generate a plurality of first aligned frames (e.g., three first aligned frames). In the present disclosure, aligning the first frame with the corresponding frame may refer to processing the first frame to be substantially identical to the corresponding frame. For example, the plurality of frames may correspond to frames that are predictively encoded and decoded based on the first frame. For example, the plurality of frames may be P-frames or B-frames.

According to an embodiment, the alignment processing unit 3210 may generate the plurality of first aligned frames by using an optical flow technique and/or a warping technique in the pixel domain. For example, the alignment processing unit 3210 may align the first frame with the plurality of consecutive frames in the first frame group by adjusting pixel positions in the first frame using optical flow and warping techniques.

According to an embodiment, the optical flow technique may be a technique for estimating pixel motion patterns in a video. The optical flow technique may be used, for example, to estimate the direction and speed of pixel motion based on brightness variations.

According to an embodiment, the alignment processing unit 3210 may identify how each pixel moves in the image by calculating the optical flow. In other words, the alignment processing unit 3210 may obtain motion information of the video by calculating the optical flow.

According to an embodiment, the alignment processing unit 3210 may obtain a flow map that contains information on how to move (or adjust the position of) each pixel in the first frame and/or the second frame using the optical flow technique, and may align the first frame and/or the second frame with the plurality of consecutive frames in the first frame group using the flow map. The optical flow technique may be an AI-based optical flow technique.

According to an embodiment, the warping technique may be a coordinate transformation technique based on images or videos. Warping may refer to transforming an image into another coordinate space using a specific transformation function.

According to an embodiment, the optical flow technique and the warping technique may be used together. For example, the alignment processing unit 3210 may use the motion information of the video obtained through the optical flow technique to perform warping for transforming the frame. For example, after obtaining pixel motion information using the optical flow technique, the alignment processing unit 3210 may use the warping technique to perform transformation (e.g., pixel position adjustment) on the first and/or second frame based on the motion information, thereby generating the first and/or second aligned frames.

According to an embodiment, the alignment processing unit 3210 may perform processing to align the second frame with the plurality of consecutive frames (e.g., three consecutive frames) in the first frame group, and may generate a plurality of second aligned frames (e.g., three second aligned frames). In the present disclosure, aligning the second frame with the corresponding frame may refer to processing the second frame to be substantially identical to the corresponding frame.

According to an embodiment, the alignment processing unit 3210 may generate the plurality of second aligned frames by using the optical flow technique and/or the warping technique in the pixel domain. For example, the alignment processing unit 3210 may align the second frame with the plurality of consecutive frames in the first frame group by adjusting pixel positions in the second frame using the optical flow and warping techniques.

Through this, with respect to the same plurality of frames (e.g., three frames) to be restored within the first frame group (or the first GoP), a plurality of first aligned frames (e.g., 3 first aligned frames) based on the first frame of the first frame group (or the first GoP) and a plurality of second aligned frames (e.g., 3 second aligned frames) based on the second frame of the second frame group (or the second GoP) may be generated. These generated aligned frames may be used together to restore the corresponding plurality of frames.

According to an embodiment, the alignment processing unit 3210 may obtain first feature data associated with the plurality of first aligned frames by performing processing to align the first frame of the first frame group (or the first GoP) with the plurality of frames within the first frame group (or the first GoP). For example, the alignment processing unit 3210 may obtain the first feature data by using an attention-based AI model (hereinafter referred to as an attention-based AI model) in the feature domain.

According to an embodiment, the alignment processing unit 3210 may obtain second feature data associated with the plurality of second aligned frames by performing processing to align the second frame of the second frame group (or the second GoP) subsequent to the first frame group (or the first GoP) with the plurality of frames within the first frame group (or the first GoP). For example, the alignment processing unit 3210 may obtain the second feature data by using an attention-based AI model in the feature domain. The first and second feature data thus obtained may be used in place of the aligned frames to restore the corresponding frames (e.g., by the enhancement network 3220).

According to an embodiment, the attention-based AI model may be an attention-based deep learning network.

According to an embodiment, the attention-based AI model may emphasize or assign weights to important information in a given input for learning. This model helps the network focus on specific parts of the input and learn more important patterns.

According to an embodiment, the alignment processing unit 3210 may obtain an attention map through the attention-based AI model and, using the attention map, obtain a similarity map indicating which part of the reference frame (e.g., the first or second frame) is most similar to a specific region of the corresponding frame. Based on similarity values from this map as weights, the alignment processing unit 3210 may adopt the portion of the reference frame with the highest similarity most heavily for alignment processing.

According to an embodiment, the enhancement network 3220 may obtain a plurality of restored frames for a plurality of consecutive frames (e.g., frames t−1, t, and t+1) in the first frame group based on the first frame of the first frame group (or the first GoP) and the second frame of the second frame group (or the second GoP). In this manner, by restoring the decoded frames using not only the first frame (e.g., I-frame) used for encoding (or compression) of other frames within the frame group to which the decoded frames belong, but also the second frame (e.g., I-frame) used for encoding (or compression) of the subsequent frame group, distortion between frame groups (e.g., between GoPs) can be restored. Therefore, a visually smoothed video can be provided compared to the video reconstructed from the decoded frames.

According to an embodiment, the enhancement network 3220 may generate a plurality of restored frames based on the plurality of first aligned frames, the plurality of second aligned frames, and the plurality of frames. For example, the enhancement network 3220 may input the plurality of first aligned frames, second aligned frames, and frames into a pre-trained AI model, and obtain restored frames corresponding to each of the plurality of frames as output from the AI model.

According to an embodiment, the enhancement network 3220 may generate a plurality of restored frames based on the first feature data, second feature data, and the plurality of frames.

According to an embodiment, the enhancement network 3220 may be implemented as an enhancement model comprising a plurality of artificial neural network layers. The artificial neural network may be, for example, one of DNN, CNN, RNN, RBM, DBN, BRDNN, deep Q-networks, or a combination thereof, but is not limited thereto.

According to an embodiment, the enhancement model may include an input layer, one or more hidden layers, and an output layer. According to an embodiment, the enhancement model may include an input layer, multiple convolutional layers, fully connected layers, and an output layer.

Meanwhile, as illustrated in FIG. 21, the first frame group described above may correspond to the first GoP, and the second frame group may correspond to a second GoP subsequent to the first GoP (e.g., immediately following the first GoP, though not limited thereto). The first frame may correspond to an I-frame of the first GoP (e.g., the first frame of the first GoP), and the second frame may correspond to an I-frame of the second GoP (e.g., the first frame of the second GoP). Each of the plurality of frames may correspond to a P-frame or B-frame of the first GoP.

Hereinafter, with reference to FIG. 33, the operation of the image reception device (or the alignment processing unit 3210 of the image reception device) will be illustratively described.

According to an embodiment, the alignment processing unit 3210 may obtain the I-frame within the first GoP (hereinafter, the first I-frame) and the I-frame within the second GoP (hereinafter, the second I-frame) which follows the first GoP. For example, the second GoP may be the GoP that immediately follows the first GoP, but it is not limited thereto. According to an embodiment, the image reception device may store I-frames and/or an list (intra list) of I-frames in memory for each GoP, and use the stored I-frames to restore the decoded frames.

According to an embodiment, the alignment processing unit 3210 may obtain a plurality of decoded frames to be restored. For example, as illustrated in FIG. 33, the alignment processing unit 3210 may obtain three consecutive P-frames belonging to the first GoP (e.g., three consecutive P-frames at times t−1, t, and t+1).

According to an embodiment, the decoded frames may have been decoded by a decoder (e.g., decoder 122 of FIG. 2A), and then frame-interpolated by a frame interpolation processing module (e.g., frame interpolation processing module 1010 of FIG. 10).

According to an embodiment, the alignment processing unit 3210 may perform processing to align the first I-frame with the plurality of consecutive frames of the first GoP to generate a plurality of first aligned frames. In this disclosure, aligning the I-frame with a given P-frame may refer to processing the I-frame to be substantially identical to the P-frame. For example, the alignment processing unit 3210 may transform the first I-frame into three first aligned frames corresponding to the three P-frames by adjusting pixel positions within the first I-frame using an optical flow technique and/or a warping technique.

According to an embodiment, the alignment processing unit 3210 may perform processing to align the second I-frame with the plurality of consecutive frames of the first GoP to generate a plurality of second aligned frames. In this disclosure, aligning the I-frame with a given P-frame may also refer to processing the I-frame to be substantially identical to the P-frame. For example, the alignment processing unit 3210 may transform the second I-frame into three second aligned frames corresponding to the three P-frames by adjusting pixel positions within the second I-frame using an optical flow technique and/or a warping technique.

The plurality of first aligned frames (e.g., three first aligned frames) and the plurality of second aligned frames (e.g., three second aligned frames) thus generated may be delivered to the enhancement network together with the plurality of decoded frames (e.g., three decoded frames).

The enhancement network 3220 may input the plurality of first aligned frames, the plurality of second aligned frames, and the plurality of frames into a pre-trained AI model, and obtain, as output data from the AI model, restored frames corresponding to each of the plurality of input frames. In this way, by restoring the decoded frames using not only the I-frame in the same GoP to which the frames belong but also the I-frame in the subsequent (or adjacent) GoP, distortion between GoPs can be effectively restored. Accordingly, a visually smoothed video can be provided compared to the video constructed using only the decoded P-frames.

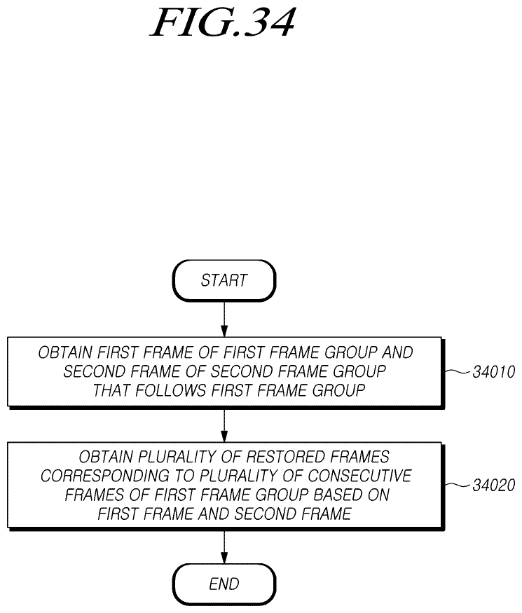

FIG. 34 is a flowchart of an image processing method of an image reception device according to an embodiment of the present disclosure.

In the embodiment of FIG. 34, the video processing method may be performed by a GoP enhancement processing module (e.g., GoP enhancement processing module 3110 in FIG. 31) within a post-processing unit (e.g., post-processing unit 123 in FIG. 2A or post-processing unit 123a in FIG. 2B) that operates after the operation of a decoder (e.g., decoder 122 in FIG. 2A or codec processing unit 122a in FIG. 2B). Therefore, the frames input for the video processing in FIG. 34 may correspond to frames that have been decoded by the decoder.

Referring to FIG. 34, the image reception device (e.g., image reception device 120 of FIGS. 1 and 2A/B) may obtain a first frame of a first frame group and a second frame of a second frame group that follows the first frame group (34010).

The image reception device may obtain a plurality of restored frames corresponding to a plurality of consecutive frames of the first frame group based on the first frame and the second frame (34020).

According to an embodiment, the first frame and the second frame may correspond to frames that are independently encoded and/or decoded, and the plurality of frames may correspond to frames encoded and/or decoded based on the first frame (e.g., predictively encoded and/or decoded frames).

According to an embodiment, the first frame group may correspond to a first GoP, and the second frame group may correspond to a second GoP immediately following the first GoP. In an embodiment, the first frame may correspond to an I-frame which is the first frame of the first GoP, and the second frame may correspond to an I-frame which is the first frame of the second GoP. Each of the plurality of frames may correspond to a P-frame or a B-frame of the first GoP. The number of consecutive frames may be three.

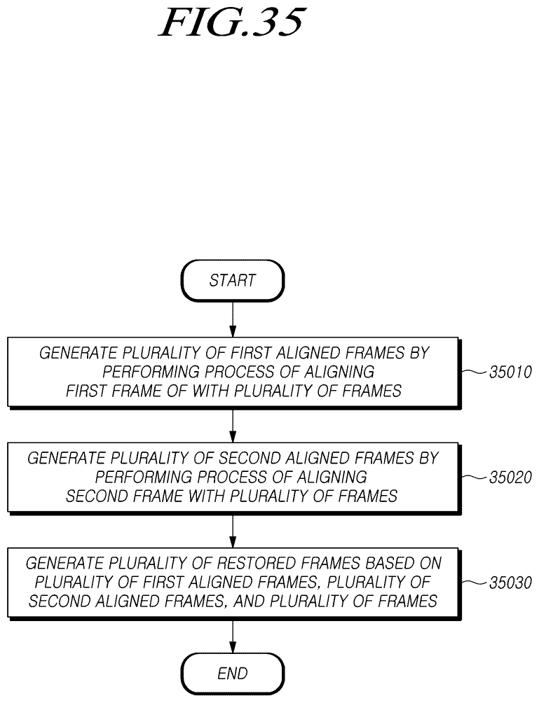

FIG. 35 is a flowchart of an alignment processing operation of an image reception device according to an embodiment of the present disclosure.

In the embodiment of FIG. 35, the alignment processing may be performed by an alignment processing unit (e.g., alignment processing unit 3210 of FIG. 32) within a post-processing unit (e.g., post-processing unit 123 in FIG. 2A or post-processing unit 123a in FIG. 2B) that operates after the operation of the decoder (e.g., decoder 122 in FIG. 2A or codec processing unit 122a in FIG. 2B). Therefore, the frames input for the alignment processing operation of FIG. 35 may correspond to frames that have been decoded by the decoder.

Referring to FIG. 35, the image reception device (e.g., image reception device 120 of FIGS. 1 and 2A/B) may perform a process of aligning a first frame of a first frame group (or a first GoP) with a plurality of frames in the first frame group, and may generate a plurality of first aligned frames (35010).

The image reception device may perform a process of aligning a second frame of a second frame group (or a second GoP), which follows the first frame group, with the plurality of frames of the first frame group, and may generate a plurality of second aligned frames (35020).

The image reception device may generate a plurality of restored frames for the plurality of frames based on the plurality of first aligned frames, the plurality of second aligned frames, and the plurality of frames (35030).

According to an embodiment, the operations of generating the plurality of first aligned frames and the plurality of second aligned frames may be performed using an optical flow technique and a warping technique in the pixel domain.

According to an embodiment, to generate the plurality of first aligned frames, the image reception device may adjust the positions of pixels in the first frame using the optical flow technique and the warping technique, thereby transforming the first frame into the plurality of first aligned frames aligned with each of the plurality of frames.

According to an embodiment, to generate the plurality of second aligned frames, the image reception device may adjust the positions of pixels in the second frame using the optical flow technique and the warping technique, thereby transforming the second frame into the plurality of second aligned frames aligned with each of the plurality of frames.

According to an embodiment, to generate the plurality of restored frames, the image reception device may input the plurality of first aligned frames, the plurality of second aligned frames, and the plurality of frames into a pre-trained artificial intelligence model as input data, and may obtain, from the artificial intelligence model, restored frames corresponding to each of the plurality of frames as output data.

According to an embodiment, to generate the plurality of restored frames, the image reception device may perform a process of aligning the first frame with the plurality of frames to obtain first feature data associated with the plurality of first aligned frames, perform a process of aligning the second frame with the plurality of frames to generate second feature data associated with the plurality of second aligned frames, and generate the plurality of restored frames based on the first feature data, the second feature data, and the plurality of frames.

According to an embodiment, the operations of obtaining the first feature data and obtaining the second feature data may be performed using an attention mechanism-based artificial intelligence model in the feature domain.

Meanwhile, the embodiments described in FIGS. 3 to 16 (e.g., frame skipping/frame interpolation/quality enhancement techniques-first embodiment), the embodiments described in FIGS. 17 to 28 (e.g., down-sampling/latent vector/SR techniques-second embodiment), and the embodiments described in FIGS. 29 to 35 (e.g., GoP enhancement techniques-third embodiment) may be combined with each other to the extent they are not contradictory. For example, frame skipping, down-sampling, and/or latent vector techniques may be used in combination for preprocessing before encoding, and frame interpolation, quality enhancement, SR, and/or GoP enhancement techniques may be used in combination for post-processing after decoding. For instance, frame skipping, down-sampling, and/or latent vector techniques may be used in combination for compression-side preprocessing. Likewise, frame interpolation, quality enhancement, and/or SR processing may be followed by GoP enhancement processing for restoration-side post-processing. These are merely examples, and the respective techniques may be combined in various orders and manners.

According to an embodiment, a method of an image transmission device may include: obtaining image data comprising a plurality of image frames; performing preprocessing on the image data; encoding the preprocessed image data to generate encoded image data; and transmitting the encoded image data and information related to the preprocessing.

According to an embodiment, the image transmission device may include a memory, a communication unit, and at least one processor, wherein the at least one processor is configured to perform the operations of obtaining image data comprising a plurality of image frames, performing preprocessing on the image data, encoding the preprocessed image data to generate encoded image data, and transmitting the encoded image data and the information related to the preprocessing.

In an embodiment, the operation of performing the preprocessing may include at least one of the operations described in the first embodiment (FIGS. 3 to 16). In another embodiment, the preprocessing may include at least one of the operations described in the second embodiment (FIGS. 17 to 28). The operations of the first embodiment (e.g., operations of frame skipping processing module 310) may be performed before the operations of the second embodiment (e.g., operations of down-sampling processing module 1710 and/or latent vector generation processing module 1720), but are not limited thereto.

According to an embodiment, a method of an image reception device may include: obtaining image data; decoding the image data, and performing post-processing on the image data based on information related to the preprocessing.

According to an embodiment, the image reception device may include a memory, a communication unit; and at least one processor, wherein the at least one processor is configured to perform the operations of obtaining image data, decoding the image data, and performing post-processing on the image data based on the preprocessing-related information.

According to an embodiment, the post-processing may include at least one of the operations described in the first embodiment (FIGS. 3 to 16). According to an embodiment, the post-processing may include at least one of the operations described in the second embodiment (FIGS. 17 to 28). In a further embodiment, the post-processing may include at least one of the operations of the first embodiment (FIGS. 3 to 16).

According to an embodiment, the operations of the first embodiment (e.g., operations of the frame interpolation processing module 1010 and/or quality enhancement processing module 1020) may be performed before the operations of the second embodiment (e.g., operations of the super-resolution processing module 2110), but are not limited thereto. In an embodiment, the operations of the second embodiment (e.g., operations of the super-resolution processing module 2110) may be performed before the operations of the third embodiment (e.g., operations of the GoP enhancement processing module 3110), but are not limited thereto.

FIG. 36 is a diagram illustrating a format for storing codec metadata according to an embodiment of the present disclosure.

According to an embodiment, the metadata of a codec (e.g., an AI codec) may include frame skip information and/or latent vector data.

Referring to FIG. 36, the metadata of the codec may be stored in the ISO file format (e.g., ISO BMFF (Base Media File Format)). The ISO file format is a standardized format compatible with formats such as MP4 or MOV. The ISO file format is organized in units of boxes (or atoms) and has a tree-like structure. Each box may have a minimum size of 8 bytes, where the first 4 bytes represent the total size of the box, and the next 4 bytes store an ID (type) that identifies each box.

Table 1 below shows an example of boxes in the ISO file format:

TABLE 1

| Box Name | |
|---|---|
| (FourCC) | Description |
| ftyp | Basic header of the ISO file format |
| mdat | Media data itself, such as video and audio (mainly |
| | compressed) |
| moov | Metadata for the stored media data (information |
| | necessary for media playback) |

Table 2 below shows examples of boxes included in the moov box:

TABLE 2

| Box Name | |
|---|---|
| (FourCC) | Description |
| mvhd | Basic information about the media (creation date, total |
| | playback time, etc.) |
| trak | Metadata representing a single media stream (multiple |
| | trak boxes can exist) |
| udta | User-defined additional data |

According to an embodiment, the codec metadata may be included in a trak box. For example, in a media file containing one video and one audio track along with codec metadata, there may be three trak boxes inside the moov box: one for video, one for audio, and one for the codec metadata. However, this is not limiting, and the number of trak boxes for video, audio, and metadata can be variably configured.

According to an embodiment, a trak box may include one or more other boxes. For instance, the trak box may include an stsd box that stores codec information necessary for decoding the media represented by that trak. The codec metadata can be included in the stsd box. As illustrated in FIG. 36, the trak box may include an mdia box, which includes a minf box, which in turn includes an stbl box. The stbl box may include an stsd box and/or an stts box. The stsd box may include an aicm box that contains the codec metadata. However, the name and structure of the box containing the codec metadata may vary and be modified.

According to an embodiment, the stts box may include timestamp information. For example, if synchronization is needed between the codec metadata and video codec, timestamp information may be included both in the stts box of the trak for codec metadata and in the stts box of the trak for video. In this case, the timestamp values in the stts boxes of the respective trak boxes can be set to the same values for synchronization between video and codec metadata.

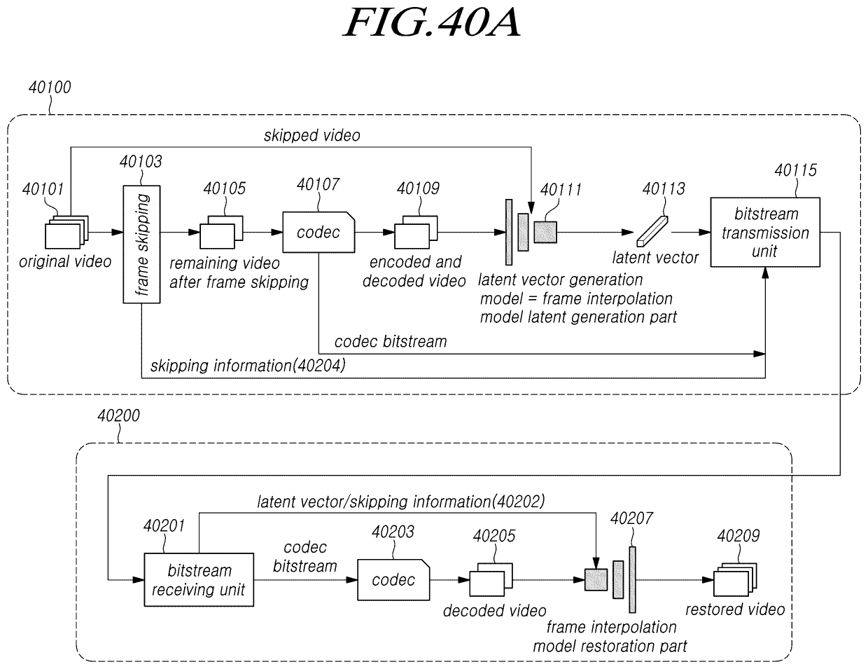

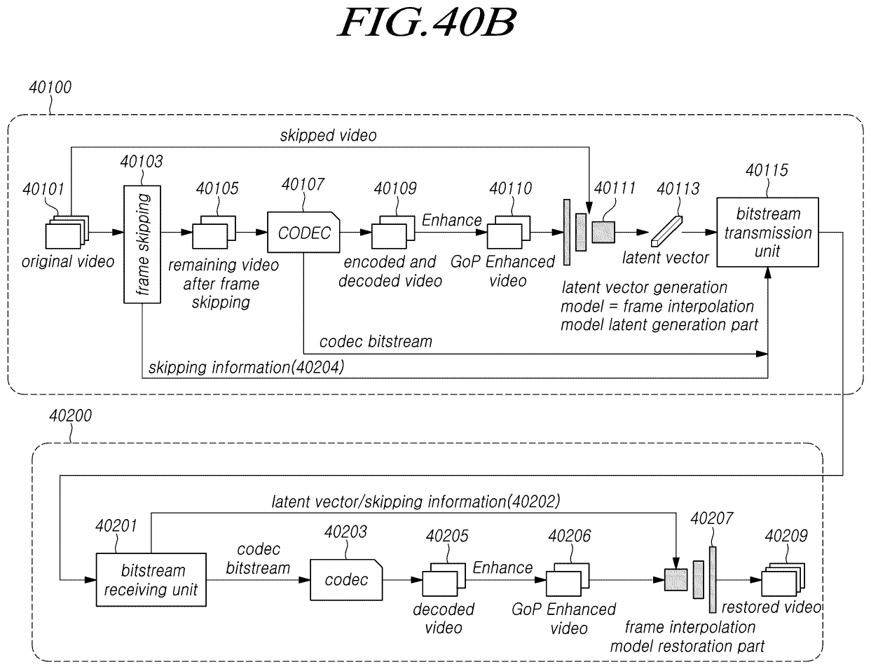

According to an embodiment, the codec metadata (e.g., AI codec metadata) may include information related to preprocessing (e.g., frame skip information) and/or latent vector data (e.g., the latent vector data 39113 in FIGS. 39A and 39B or 40113 in FIGS. 40A and 40B).

According to an embodiment, the codec metadata may be stored in a trak box of the ISO file format. It may be stored in a trak box separate from the ones for video and audio data. For example, the codec metadata may be included in an stsd box within the metadata trak. For example, the codec metadata may be included in an aicm box inside the stsd box.

According to an embodiment, the number of trak boxes for codec metadata may be the same as that for video data.

The timestamp values in the stts box of the trak for codec metadata may be set to the same values as those in the stts box of the corresponding trak for video data, to enable synchronization.

According to an embodiment, the image reception device may decode (or retrieve) the codec metadata from the trak for codec metadata, and reproduce the media data (e.g., video data) using the codec metadata.

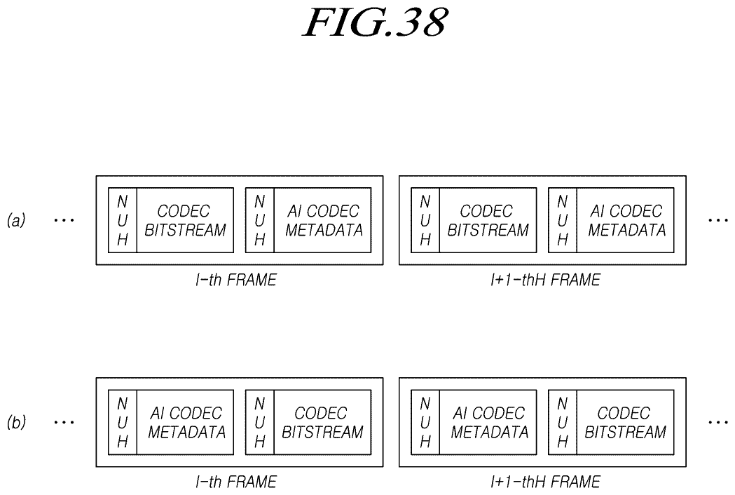

FIGS. 37 and 38 are diagrams illustrating a method for transmitting media data and metadata according to an embodiment of the present disclosure.

Referring to FIG. 37, media data (e.g., video data) for each frame and an associated signaling message (e.g., a supplemental enhancement information (SEI) message) may be transmitted together.

According to an embodiment, the data of the SEI message may be transmitted after the video data for the corresponding frame (i.e., in a suffix case). For example, as illustrated in part (a) of FIG. 37, the data (or container) for a first frame (e.g., i-th frame) may include a first unit including the video data of the first frame and a NAL unit header (NUH), and a second unit including the data of an associated SEI message and a NUH. The second unit may follow the first unit. The data (or container) for a second frame (e.g., (i+1)-th frame) following the first frame may include a first unit including the video data and NUH of the second frame, and a second unit including the data of an associated SEI message and a NUH. The second unit may follow the first unit.

According to another embodiment, the data of the SEI message may be transmitted before the video data of the corresponding frame (i.e., in a prefix case). For example, as illustrated in part (b) of FIG. 37, the data (or container) for a first frame (e.g., i-th frame) may include a first NAL unit including the video data of the first frame and a NAL unit header (NUH), and a second NAL unit including the data of an associated SEI message and a NUH. The second NAL unit may precede the first NAL unit. The data (or container) for a second frame (e.g., (i+1)-th frame) following the first frame may include a first NAL unit including the video data and NUH of the second frame, and a second NAL unit including the data of an associated SEI message and a NUH. The second NAL unit may precede the first NAL unit.

According to an embodiment, codec metadata (e.g., for an AI codec) may be transmitted together with media data (e.g., video data encoded by the codec, i.e., a codec bitstream) for the corresponding frame. For example, the codec metadata may be included in the region where the SEI message data is transmitted. The codec metadata may include, for instance, frame skipping information and/or latent vector data.

According to an embodiment, the codec metadata may be transmitted after the video data (e.g., codec bitstream) for the corresponding frame (i.e., in a suffix case). For example, as illustrated in part (a) of FIG. 38, the data (or container) for a first frame (e.g., i-th frame) may include a first NAL unit including the video data (e.g., codec bitstream) and NUH of the first frame, and a second NAL unit including associated codec metadata and a NUH. The second NAL unit may follow the first NAL unit. The data (or container) for a second frame (e.g., (i+1)-th frame) following the first frame may include a first NAL unit including the video data (e.g., codec bitstream) and NUH of the second frame, and a second unit including associated codec metadata and a NUH. The second NAL unit may follow the first NAL unit.

According to an embodiment, the codec metadata may be transmitted before the video data (e.g., codec bitstream) for the corresponding frame (i.e., in a prefix case). For example, as illustrated in part (b) of FIG. 37, the data (or container) for a first frame (e.g., i-th frame) may include a first NAL unit including the video data (e.g., codec bitstream) and NUH of the first frame, and a second NAL unit including associated codec metadata and a NUH. The second NAL unit may precede the first NAL unit. The data (or container) for a second frame (e.g., (i+1)-th frame) following the first frame may include a first NAL unit including the video data (e.g., codec bitstream) and NUH of the second frame, and a second NAL unit including associated codec metadata and a NUH. The second NAL unit may precede the first NAL unit.

According to an embodiment, when the codec metadata is transmitted before the codec bitstream (i.e., in the prefix case), the NAL unit type information for the NAL unit containing the codec metadata may be set to a first value (e.g., 39). When the codec metadata is transmitted after the codec bitstream (i.e., in the suffix case), the NAL unit type information for the NAL unit containing the codec metadata may be set to a second value (e.g., 40). The NAL unit type information may be included in the NUH of the NAL unit containing the codec metadata.

Table 3 below illustrates an example of a syntax of an SEI message including codec metadata.

TABLE 3

| | Descriptor |
|---|---|
| sei_message( ) { | |
| payloadType = 0 | |
| while( next_bits( 8 ) = = 0xFF ) { | |
| ff_byte /* equal to 0xFF */ | f(8) |
| payloadType += 255 | |
| } | |
| last_payload_type_bytes | u(8) |
| payloadType += last_payload_type_byte | |
| payloadSize = 0 | |
| while( next_bits( 8 ) = = 0xFF ) { | |
| ff_byte /* equal to 0xFF */ | f(8) |
| payloadSize += 255 | |
| } | |
| last_payload_size_byte | u(8) |
| payloadSize += last_payload_size_byte | |
| sei_payload( payloadType, payloadSize ) | |
| } | |

Referring to Table 3, an SEI message may include a payloadType field (information), a payloadSize field (information), and a sei_payload field (information).

According to an embodiment, the codec metadata (e.g., AI codec metadata) may include, for example, information related to preprocessing (e.g., frame skipping information) and/or latent vector data (e.g., latent vector data 39113 in FIGS. 39A and 39B, latent vector data 40113 in FIGS. 40A and 40B).

According to an embodiment, the codec metadata may be included in the sei_payload field. When the codec metadata is included in the sei_payload field, the payloadType field may be set to a value (e.g., 500) indicating that the SEI message (or the sei_payload field) includes codec metadata, and the payloadSize field may be set to a value indicating the size (e.g., byte size) of the codec metadata included in the sei_payload field.

Table 4 below illustrates an example of a sei_payload field including codec metadata (e.g., AI codec metadata), and Table 5 illustrates an example of codec metadata included in the sei_payload field.

TABLE 4

Descriptor

```
sei_payload(payloadType, payloadSize) {
  if(nal_unit_type == PREFIX_SEI_NUT ||
nal_unit_type == SUFFIX_SEI_NUT)
    if(payloadType == 500) {
      ai_codec_metadata(payloadSize)
    }
}
```

TABLE 5

| | Descriptor |
|---|---|
| ai_codec_metadata(payloadSize){ | u(1) |
| ai_codec_frame_skip_flag | |
| if(ai_codec_frame_skip_flag){ | |
| metadata_block(payloadSize) | |
| } | |

Referring to Table 4, the sei_payload field may include a codec metadata field (e.g., an ai_codec_metadata field) that includes codec metadata (e.g., AI codec metadata).

Referring to Table 5, the ai_codec_metadata field may include an ai_codec_frame_skip_flag field.

The ai_codec_frame_skip_flag field may indicate whether the video data of the corresponding frame has been skipped. When the ai_codec_frame_skip_flag field indicates that the video data of the corresponding frame has been skipped (e.g., ai_codec_frame_skip_flag field=1), the ai_codec_metadata field may include a metadata_block field. The metadata_block field may include information indicating at least one block that has been skipped in the corresponding frame.

According to an embodiment, the image receiving device may decode an SEI message located before or after the codec metadata and acquire the codec metadata included in the SEI message.

According to an embodiment, when the codec metadata is included in the SEI message, the payloadType field of the SEI message may be set to a value (e.g., 500) indicating that the SEI message (or the sei_payload field) includes codec metadata.

According to an embodiment, the image receiving device may determine whether the video data of the corresponding frame has been skipped by using the value of a flag field (e.g., the ai_codec_frame_skip_flag) included in the codec metadata within the SEI message, and may identify a skipped block in the corresponding frame by using the value of the metadata_block field.

FIGS. 39A and 39B are diagrams illustrating a super-resolution procedure according to an embodiment of the present disclosure. In FIGS. 39A and 39B, overlapping descriptions with the explanations described in FIGS. 1 to 38 are omitted.

According to an embodiment, the super-resolution procedure may include an operation 39100 performed by the image transmission device (e.g., the image transmission device 110 of FIGS. 1 and 2A/2B) and an operation 39200 performed by the image reception device (e.g., the image reception device 120 of FIGS. 1a/1b/lc).

Referring to FIG. 39A, the image transmission device may obtain down-sampled video data 39101 (e.g., low-quality/low-capacity video). The image transmission device may perform encoding processing on the down-sampled video data 39101 using a codec processing unit 39103 (e.g., the codec processing unit 113a of FIG. 2b), thereby obtaining encoded video data (e.g., a codec bitstream), and may deliver the encoded video data to a bitstream transmission unit 39115 (e.g., the image output unit 114a of FIG. 2b). The image transmission device may perform encoding and decoding processing on the down-sampled video data 39101 using the codec processing unit 39103 (e.g., the codec processing unit 113a of FIG. 2b), thereby obtaining encoded and decoded video data 39105 (e.g., compressed decoded video=decoded video). The image transmission device may perform resolution interpolation on the encoded and decoded video data 39105, thereby obtaining resolution-interpolated video data 39107. The image transmission device may calculate a difference between the original video data 39109 and the resolution-interpolated video data 39107, and obtain loss data 39110 based on the difference.

The image transmission device may generate latent vector data 39113 based on the loss data 39110, using a pre-trained model 39111 (e.g., a latent encoder), and may deliver the latent vector data 39113 to the bitstream transmission unit 39115. The image transmission device may transmit the encoded video data (e.g., codec bitstream) and the latent vector data 39113 to the image reception device using the bitstream transmission unit 39115. The bitstream transmission unit 39115 may include the encoded video data and the latent vector data in a single container as a final bitstream and transmit them. For example, as illustrated in FIG. 38, the latent vector data may be included as codec metadata (e.g., AI codec metadata) in an SEI message and transmitted either before or after the encoded video data.

The image reception device may receive the encoded video data (e.g., codec bitstream) and the latent vector data 39113 using a bitstream receiving unit 39201 (e.g., the video input unit 221a of FIG. 2b). The bitstream receiving unit 39201 may deliver the latent vector data 39113 to an SR model 39207, and may deliver the encoded video data (e.g., codec bitstream) to a codec processing unit 39203 (e.g., the codec processing unit 122a of FIG. 2b). The image reception device may perform decoding processing on the encoded video data using the codec processing unit 39203, thereby obtaining decoded video data 39205. The image reception device may obtain restored video data 39209 (e.g., restored high-resolution video) using the SR model 39207 based on the latent vector data 39113 and the decoded video data 39205.

In the embodiment of FIG. 39B, unlike the embodiment of FIG. 39A, GoP enhancement processing may be performed in the super-resolution procedure. In FIG. 39B, overlapping descriptions with the embodiment of FIG. 39A are omitted.

Referring to FIG. 39B, in the image transmission device, GoP enhancement processing may be performed on the encoded and decoded video data 39105. Through this, the image reception device may obtain GoP-enhanced video data 39106, and may perform resolution interpolation on the GoP-enhanced video data 39106 to obtain resolution-interpolated video data 39107.

In the image reception device, GoP enhancement processing may be performed on the decoded video data 39205. Through this, the image reception device may obtain GoP-enhanced video data 39206, and may use the GoP-enhanced video data 39206 as input data for the SR model 39207.

FIGS. 40A and 40B are diagrams illustrating a frame skipping procedure according to an embodiment of the present disclosure. In FIGS. 40A and 40B, overlapping descriptions with the explanations described in FIGS. 1 to 38 are omitted.

According to an embodiment, the frame skipping procedure may include an operation 40100 performed by the image transmission device (e.g., the image transmission device 110 of FIGS. 1 and 2A/2B) and an operation 40200 performed by the image reception device (e.g., the image reception device 120 of FIGS. 1 and 2A/2B).

Referring to FIG. 40A, the image transmission device may obtain original video data 40101 including a plurality of frames (e.g., original video), and may deliver the obtained original video data 40101 to a frame skipping processing unit 40103 (e.g., the frame skipping processing module (310) of FIG. 3). The image transmission device may skip at least one of the plurality of frames or at least one of blocks included in at least one frame using the frame skipping processing unit 40103. The frame skipping processing unit 40103 may deliver the skipped video data to a latent vector generation model 40111, and may deliver the skipped and remaining video data 40105 to a codec processing unit 40107 (e.g., the codec processing unit 113a of FIG. 2B). The frame skipping processing unit 40103 may deliver frame skip information to a bitstream transmission unit 40115 (e.g., the image output unit 114a of FIG. 2B). The image transmission device may perform encoding processing on the video data 40105 using the codec processing unit 40107, thereby obtaining encoded video data (e.g., codec bitstream), and may deliver it to the bitstream transmission unit 40115. The image transmission device may perform encoding and decoding processing on the video data 40105 using the codec processing unit 40107, thereby obtaining encoded and decoded video data 40109 (e.g., compressed and decoded video). The image transmission device may obtain latent vector data 40113 by using the latent vector generation model 40111 based on the skipped video data and the encoded/decoded video data 40109. The latent vector data 40113 may include information used to restore the skipped frame(s) or skipped block(s). The image transmission device may transmit the encoded video data (e.g., codec bitstream), the latent vector data 40113, and the frame skip information to the image reception device using the bitstream transmission unit 40115. The bitstream transmission unit 40115 may include the final bitstream containing the encoded video data (e.g., codec bitstream), the latent vector data 40113, and the frame skip information in a single container and transmit it. For example, as illustrated in FIG. 38, the latent vector data and the frame skip information may be included as codec metadata (e.g., AI codec metadata) in an SEI message, and may be transmitted either before or after the encoded video data.

The image reception device may receive the encoded video data (e.g., codec bitstream), the frame skip information, and the latent vector data 40113 using a bitstream receiving unit 40201 (e.g., the video input unit 221a of FIG. 2B). The bitstream receiving unit 40201 may deliver the latent vector data 40113 and the frame skip information to a frame interpolation model 40207, and may deliver the encoded video data (e.g., codec bitstream) to a codec processing unit 40203 (e.g., the codec processing unit 122a of FIG. 2B). The image reception device may perform decoding processing on the encoded video data using the codec processing unit 40203, thereby obtaining decoded video data 40205. The image reception device may obtain restored video data 40209 (e.g., restored high-resolution video) by using the frame interpolation model 40207 based on the frame skip information, the latent vector data 40202, and the decoded video data 40205. The frame interpolation model 40207 may be used to restore the original video through frame interpolation.

In the embodiment of FIG. 40B, unlike the embodiment of FIG. 40A, GoP enhancement processing may be performed in the frame skipping procedure. In FIG. 40B, overlapping descriptions with the embodiment of FIG. 40A are omitted.

Referring to FIG. 40B, in the image transmission device, GoP enhancement processing may be performed on the encoded and decoded video data 40105. Through this, the image reception device may obtain GoP-enhanced video data 40106, and may use the GoP-enhanced video data 40106 as input data for the latent vector generation model 40111.

In the image reception device, GoP enhancement processing may be performed on the decoded video data 40205. Through this, the image reception device may obtain GoP-enhanced video data 40206, and may use the GoP-enhanced video data 40206 as input data for the latent vector generation model 40111.

In the above-described specific embodiments of the present disclosure, the components included in the present disclosure are expressed in singular or plural according to the presented specific embodiments. However, the singular or plural expressions are selected suitably for the situation presented for convenience of explanation, and the present disclosure is not limited to singular or plural components. Even if a component is expressed in plural, it may be composed of a single one, and even if a component is expressed in singular, it may be composed of plural ones.

Meanwhile, although specific embodiments have been described in detail in the detailed description of the present disclosure, various modifications are, of course, possible within the scope not departing from the present disclosure. Therefore, the scope of the present disclosure should not be determined as being limited to the described embodiments, but should be defined by not only the claims to be described later but also equivalents thereof.

1. A method performed by an image transmission device, the method comprising:
obtaining first image data including a first image frame and a second image frame;
determining whether to apply frame skipping to the first image frame;
in case that it is determined to apply the frame skipping to the first image frame, skipping data of the first image frame;
encoding second image data, which is image data from the first image data excluding the skipped data;
generating latent vector data using the second image data and third image data, the third image data including the skipped data; and
transmitting the encoded second image data, frame skipping-related information, and the latent vector data,
wherein the frame skipping-related information includes first information indicating that the frame skipping is applied to the first image frame.

2. The method of claim 1,
wherein the encoded second image data includes data of an encoded second image frame, and the frame skipping-related information includes second information indicating that frame skipping is not applied to the second image frame,
wherein the transmitting of the encoded second image data comprises:
transmitting a first container associated with the first image frame and a second container associated with the second image frame,
wherein the second container includes:
a first unit including the data of the encoded second image frame, and
a second unit including data of a signaling message associated with the second image frame, and
wherein the signaling message includes at least one of at least a part of the latent vector data and the second information.

3. The method of claim 2,
wherein the encoded second image data includes encoded block data generated by encoding at least one first block of the first image frame to which frame skipping is not applied,
wherein the frame skipping-related information further includes third information indicating at least one second block of the first image frame to which frame skipping is applied,
wherein the first container includes:
a first unit including the encoded block data, and
a second unit including data of a signaling message associated with the first image frame, and
wherein the signaling message includes at least a part of the latent vector data, at least one of the first information and the third information.

4. The method of claim 3,
wherein the first unit and the second unit correspond to network abstraction layer (NAL) units,
wherein the signaling message corresponds to a supplemental enhancement information (SEI) message, and
wherein the SEI message includes information indicating that at least a part of the latent vector data and metadata including at least one of the first information and the second information is included in the SEI message or in a payload of the SEI message.

5. The method of claim 1,
wherein the determining of whether to apply the frame skipping comprises:
selecting an artificial intelligence model from a plurality of artificial intelligence models based on a parameter set for encoding the image data; and
determining whether to apply the frame skipping using the selected artificial intelligence model,
wherein the encoding of the second image data comprises:
encoding the second image data using the parameter set for the encoding, and
wherein the parameter for the encoding is associated with a compression rate of the image data.

6. The method of claim 5,
wherein the artificial intelligence model is configured to output a distance associated with a difference between a first distortion and a second distortion at a same bit rate,
wherein the first distortion is associated with a first image frame set to which the frame skipping is applied,
wherein the second distortion is associated with a second image frame set to which the frame skipping is not applied,
wherein the first image frame set includes the second image frame which precedes the first image frame and a third image frame which follows the first image frame, and
wherein the second image frame set includes the first image frame, the second image frame, and the third image frame.

7. The method of claim 6,
wherein the determining of whether to apply the frame skipping to the first image frame comprises:
encoding and decoding the first image frame, the second image frame preceding the first image frame, and the third image frame following the first image frame;
inputting the encoded and decoded first image frame, the encoded and decoded second image frame, and the encoded and decoded third image frame into the artificial intelligence model as input data and obtaining the distance as output data of the artificial intelligence model; and
determining whether to apply the frame skipping to the first image frame based on the distance,
wherein the distance corresponds to a value obtained by subtracting the second distortion from the first distortion, and
wherein the determining of whether to apply the frame skipping to the first image frame based on the distance comprises:
determining to apply the frame skipping to the first image frame when the distance is negative; and
determining not to apply the frame skipping to the first image frame when the distance is positive.

8. The method of claim 5,
wherein the artificial intelligence model is trained based on a plurality of training datasets,
wherein each of the training datasets is obtained based on:
obtaining an image frame set;
performing a first image processing for each of a plurality of configurable values of the parameter for the encoding to obtain first rate-distortion data;
performing a second image processing for an image frame set to which the frame skipping is applied using a target value of the parameter for the encoding to obtain second rate-distortion data; and
obtaining a distance based on the first rate-distortion data and the second rate-distortion data, and
wherein the first image processing includes encoding and decoding processing, and the second image processing includes encoding, decoding, frame interpolation, and quality enhancement processing.

9. The method of claim 1,
wherein the generating of the latent vector data comprises:
performing encoding and decoding of the second image data;
obtaining loss data based on the third image data and the encoded and decoded image data; and
generating the latent vector data using an artificial intelligence model based on the loss data.

10. The method of claim 1, wherein the generating of the latent vector data comprises:
down-sampling the second image data to obtain down-sampled image data;
encoding and decoding the down-sampled image data;
performing resolution interpolation on the encoded and decoded image data to obtain resolution-interpolated image data;
obtaining loss data based on the third image data and the resolution-interpolated image data; and
generating the latent vector data using an artificial intelligence model based on the loss data.

11. The method of claim 10,
wherein the obtaining of the loss data comprises:
calculating a difference of a predetermined unit for a frame pair including a first frame included in the first image data and a second frame corresponding to the first frame and included in the resolution-interpolated image data, and
wherein the predetermined unit corresponds to a pixel unit.

12. (canceled)

13. A method performed by an image reception device, the method comprising:
receiving encoded image data, frame skipping-related information, and latent vector data, wherein the encoded image data is generated by encoding image data including a first image frame and a second image frame;
decoding the encoded image data; and
processing the decoded image data based on the frame skipping-related information and the latent vector data,
wherein the frame skipping-related information includes first information indicating whether frame skipping is applied to the first image frame.

14. The method of claim 13,
wherein the encoded image data includes data of an encoded second image frame,
wherein the frame skipping-related information includes second information indicating that frame skipping is not applied to the second image frame,
wherein the receiving of the encoded image data comprises:
receiving a first container associated with the first image frame and a second container associated with the second image frame,
wherein the second container includes:
a first unit including the data of the encoded second image frame; and
a second unit including data of a signaling message associated with the second image frame, and
wherein the signaling message includes at least one of at least a part of the latent vector data and the second information.

15. The method of claim 13, wherein the processing of the decoded image data comprises:
determining whether to apply frame interpolation to a plurality of image frames included in the image data based on the frame skipping-related information;
when it is determined to apply frame interpolation to the plurality of image frames, obtaining interpolated image data for the first image frame using a first artificial intelligence model based on the plurality of image frames; and
obtaining enhanced image data using a second artificial intelligence model based on the interpolated image data for the first image frame.

16. The method of claim 13,
wherein the processing of the decoded image data comprises:
generating resolution-enhanced image data using an artificial intelligence model based on the latent vector data,
wherein the latent vector data is generated based on loss data used for restoration of the decoded image data,
wherein the loss data is obtained by calculating a difference of a predetermined unit for an associated frame pair, and
wherein the predetermined unit corresponds to a pixel unit.

17. The method of claim 13,
wherein the processing of the decoded image data comprises:
obtaining a first frame of a first frame group included in the image data and a second frame of a second frame group subsequent to the first frame group; and
obtaining a plurality of reconstructed frames for a plurality of consecutive frames of the first frame group based on the first frame and the second frame, and
wherein the first frame and the second frame correspond to independently encoded and decoded frames, and the plurality of frames correspond to predictively encoded and decoded frames based on the first frame.

18. The method of claim 17,
wherein the first frame group corresponds to a first group of pictures (GoP),
wherein the second frame group corresponds to a second GoP that immediately follows the first GoP,
wherein the first frame corresponds to an intra-coded (I) frame of the first GoP,
wherein the second frame corresponds to an intra-coded (I) frame of the second GoP, and
wherein each of the plurality of frames corresponds to either a predictive-coded (P) frame or a bi-predictive-coded (B) frame of the first GoP.

19. The method of claim 17, wherein the generating of the plurality of reconstructed frames comprises:
performing alignment processing to align the first frame with the plurality of frames to obtain first feature data associated with a plurality of first aligned frames;
performing alignment processing to align the second frame with the plurality of frames to obtain second feature data associated with a plurality of second aligned frames; and
generating the plurality of reconstructed frames based on the first feature data, the second feature data, and the plurality of frames.

20. An image reception apparatus comprising:
memory;
a communication unit; and
at least one processor,
wherein the at least one processor is configured to:
receive encoded image data, frame skipping-related information, and latent vector data, wherein the encoded image data is generated by encoding image data including a first image frame and a second image frame;
decode the encoded image data; and
process the decoded image data based on the frame skipping-related information and the latent vector data, and
wherein the frame skipping-related information includes first information indicating whether frame skipping is applied to the first image frame.
